(19) United States
(12) Patent Application Publication
(10) Pub. No.: US 2026/0277222 A1
(43) Pub. Date: Sep. 17, 2026

(54) CONTROLLING ROBOT USING MULTI-MODEL FORCE TRACKING

(71) Applicant: Mitsubishi Electric Research Laboratories, Inc., Cambridge, MA (US)

(72) Inventors: Karl Berntorp, Cambridge, MA (US); Ziyi Zhou, Cambridge, MA (US); Stefano Di Cairano, Cambridge, MA (US); Yebin Wang, Cambridge, MA (US)

(73) Assignee: Mitsubishi Electric Research Laboratories, Inc., Cambridge, MA (US)

(21) Appl. No.: 19/077,079

(22) Filed: Mar. 12, 2025

(51) Int. Cl. G05D 1/495; G05D 1/622; G05D 1/644; G05D 109/12; G06N 7/01

(52) U.S. Cl. CPC G05D 1/495; G05D 1/622; G05D 1/644; G06N 7/01; G05D 2109/12

(57) ABSTRACT

A system and method for force-aware motion control in a robot utilizing probabilistic force estimation and adaptive control strategies. The system employs an Interacting Multiple-Model (IMM) Kalman Filter to estimate external forces acting on the robot by processing force pseudo-measurements derived from joint encoder data and robot dynamics. The IMM filter utilizes multiple probabilistic filters, each corresponding to a distinct motion mode—swing, stance, or collision—and updates mode probabilities by integrating force pseudo-measurements and robot dynamics to refine external force estimation. The estimated forces are used to refine contact mode classification and dynamically adjust the robot's trajectory in response to disturbances. The controller integrates reflex motion control and admittance motion control, wherein reflex motion control generates real-time corrective actions to counteract unexpected external disturbances, while admittance motion control applies an admittance model to regulate the robot's motion in compliance with external forces.

### TECHNICAL FIELD

This disclosure relates to the field of robotics, specifically to systems and methods for controlling quadrupedal robots. The system and methods focus on collision detection, force estimation, and adaptive control for dynamic locomotion in unstructured or challenging terrains. The disclosure leverages mode-based estimation frameworks, such as Interacting Multiple-Model Kalman Filters, and admittance control strategies to enhance the robot's adaptability and stability during operation.

### BACKGROUND

Legged robots, such as robots with quadrupedal locomotion have advanced remarkably over the past few decades, showcasing exceptional adaptability and resilience against external disturbances. These advancements have significantly broadened the application of legged robots, especially in navigating complex terrains such as stairs, uneven rocks, and rubble-strewn environments. To further enhance their capabilities on such challenging surfaces, many approaches have relied on integrating terrain information into planning and estimation modules. These modules aim to proactively reduce the likelihood of tripping by leveraging detailed environmental data.

However, the reliance on terrain information presents inherent limitations. The constrained bandwidth of sensor data, combined with potential tracking inaccuracies, often prevents the generation of reliable terrain descriptions. This issue becomes particularly pronounced for legged robots operating at high speeds, where rapid movements and minimal reaction times amplify the challenges of real-time terrain analysis. Consequently, these limitations highlight a fundamental gap in traditional systems—an over-reliance on external sensors and pre-mapped terrain data for robust navigation.

In dynamic locomotion, where high-speed and unpredictable environments are the norm, the ability to detect collisions and estimate contact forces becomes critical. A robust system must quickly and accurately distinguish between different types of interactions, such as normal gait forces, minor disturbances, or significant collisions, without depending on external sensing. This independence from external sensors not only enhances reliability but also extends the robot's adaptability to a broader range of unstructured environments.

To address these challenges, the focus shifts to proprioceptive sensing relying solely on internal data from the robot's joint encoders and dynamic models. This approach enables the robot to infer contact forces and detect collisions in real-time, leveraging its internal measurements to navigate unpredictable terrains. By prioritizing self-contained collision detection and contact force estimation, the system ensures rapid and reliable reactions to unexpected events.

The importance of robust collision detection and force estimation extends beyond preventing tripping; robust collision detection and force estimation serves as the foundation for adaptive control mechanisms that allow the robot to recover gracefully from disturbances. Such systems empower quadrupedal robots to maintain stability and momentum, even in the face of sudden impacts or environmental changes.

Accordingly, there is a need for a comprehensive approach that integrates robust internal estimation with dynamic control capabilities for advancing quadrupedal locomotion and achieving seamless operation in challenging terrains.

### SUMMARY

Some embodiments are based on the recognition that in a number of practical robotic applications, such as in quadrupedal locomotion on uneven and often unknown terrain, collisions are expected occurrences rather than anomalies. Instead of being avoided entirely, collisions may be treated as a normal aspect of the robot's operation. This perspective suggests that the design may focus on controlling the robot while simultaneously detecting and recovering from collisions. Unlike traditional control systems that treat collision detection as a process external to the control system, some embodiments integrate collision management into the control system itself. The anticipated nature of collisions in dynamic environments makes separating detection and control less efficient, potentially resulting in slower responses and limited adaptability.

To manage collisions, some embodiments distinguish between normal contact, such as during stance gait phases, and abnormal interactions, such as collisions. This distinction may involve thresholding the force estimation to identify specific contact modes, including swing, stance, and collision. However, distinguishing between multiple contact forces using thresholds for different operational modes can introduce challenges due to the variability of forces across different terrains and scenarios. Moreover, force estimation can be further complicated in the absence of direct force sensors, requiring the robot to infer forces indirectly, which may result in inaccuracies especially in presence of sensor noise.

Force estimation under noisy conditions may be performed using probabilistic filters, such as Kalman filters, which process noisy measurements to generate a refined force profile. In quadrupedal locomotion, however, under the assumption that collision is type of regular motion, the robot operates in multiple modes, such as swing, stance, and collision, each exhibiting distinct dynamics. These modes may cause discontinuities in force estimation, making probabilistic filtering more challenging. To address this, some embodiments employ a framework capable of managing multiple modes simultaneously while adapting to transitions between modes.

Some embodiments treat collision as a separate mode of operation, allowing its dynamics to be modeled alongside swing and stance modes. The Interacting Multiple-Model (IMM) framework is utilized to track different operational modes of the robot. Each mode, including collision, may be assigned a dedicated Kalman filter to estimate the relevant forces and state dynamics. The IMM framework combines these estimations using a probabilistic approach, accounting for uncertainties and transitions between modes.

The IMM framework enables seamless switching between modes and supports accurate force estimation even during abrupt transitions. In some embodiments, pseudo-measurements-approximations of forces derived from kinematic and dynamic data are integrated into the IMM framework to refine the estimation process. These pseudo-measurements provide feedback for mode identification and state adjustment. For example, in one embodiment, a Markov process within the IMM framework calculates the probability of each mode being active and updates the Kalman filters based on these probabilities, ensuring continuous operation.

Pseudo-measurements assist the IMM framework in identifying the active mode by being compared to mode-specific expectations. Each Kalman filter within the IMM is tailored to a specific mode, such as swing, stance, or collision, and predicts the forces and state dynamics associated with that mode. These pseudo-measurements are fed into the IMM framework as feedback, allowing the system to evaluate how closely they align with the expected behavior of each mode. For example, pseudo-measurements indicating forces near zero increase the likelihood of swing mode, while spikes in pseudo-measurements suggest a higher probability of collision mode.

In some embodiments, admittance control is employed to leverage estimated force information to make the robot's motion more compliant and adaptive. Admittance control modifies the robot's trajectory based on the estimated forces, enabling smoother reactions to collisions and better integration with dynamic environments. In the absence of direct force sensors, the forces may be estimated using kinematic and dynamic data derived from the robot's motion. In general, while feasible, this estimation process may be susceptible to noise, adding complexity to the overall control system. However, this complexity can be mitigated by the IMM framework.

To that end, in certain embodiments, the IMM framework outputs are integrated into an admittance control system, creating a unified approach that combines force estimation and motion adaptation. This integration allows the robot to respond dynamically to collisions, recover effectively, and maintain stability across diverse terrains. Additionally or alternatively, the estimated forces from the IMM framework may be fed into a reflex motion controller. The reflex controller may adjust the swing leg trajectory in response to detected collisions, while the admittance control system ensures compliant motion to minimize disruptions and maintain stability.

In some embodiments, the IMM framework is further integrated with a Model Predictive Controller (MPC) to enhance balancing and disturbance rejection. The MPC uses the estimated external forces to adapt the robot's motion plan dynamically in response to collisions. This layered approach supports not only the detection and recovery from collisions but also robust and stable locomotion across varied and unpredictable environments.

Accordingly, one embodiment discloses a probabilistic feedback controller for controlling an operation of a robot using a probabilistic filter employing an interacting multiple-model (IMM) framework, comprising: at least one processor; and a memory having instructions stored thereon that, when executed by the at least one processor, cause the controller to: process digital representations of measurements of a motion of the robot to estimate force pseudo-measurements of an external force acting on the robot during the motion; execute an IMM filter configured to recursively estimate the external force using multiple probabilistic filters tracking the external force according to the force pseudo-measurements, each of the multiple probabilistic filters is associated with distinct dynamics of a mode of the motion of the robot to produce a force estimation of the mode and a probability of the mode, wherein the IMM filter combines the force estimation of different modes according to their probabilities to produce the estimate of the external force; and control the operation of the robot based on the estimate of the external force using one or both of a reflex motion control and an admittance motion control.

Another embodiment discloses a method for controlling a quadrupedal robot using probabilistic force estimation and adaptive motion control, wherein the method uses a processor coupled with stored instructions implementing the method, wherein the instructions, when executed by the processor carry out steps of the method, including: processing digital representations of measurements of the motion of the robot to estimate force pseudo-measurements corresponding to external forces acting on the robot; executing an interacting multiple-model (IMM) filter to recursively estimate external forces, wherein the IMM filter comprises multiple probabilistic filters, each associated with a distinct motion mode of the robot, including swing, stance, and collision modes; determining the probability of each motion mode being active based on the estimated force pseudo-measurements and robot dynamics, wherein the IMM filter updates mode probabilities and refines the external force estimation by combining the outputs of the mode-specific probabilistic filters; and generating motion control commands based on the estimated external forces, wherein the controller applies one or both of reflex motion control and admittance motion control to modify the trajectory of the quadrupedal robot in response to disturbances and control the robot according the modified trajectory.

### BRIEF DESCRIPTION OF DRAWINGS

FIG. 1 illustrates a block diagram of a control system for controlling an operation of a legged robot, according to some embodiments of the present disclosure.

FIG. 2 illustrates a probabilistic filter estimating a state of a legged robot according to some embodiments of the present disclosure.

FIG. 3 illustrates a flow chart of a method for adjusting a reference trajectory in response to estimating an external contact force for the legged robot according to some embodiments of the present disclosure.

FIG. 4 illustrates a block diagram of a control system for initiating and controlling an operation of a legged robot.

FIG. 5A illustrates the probabilistic filter 170, for example the Kalman filter for estimating the external force, according to some embodiments of the present disclosure.

FIG. 5B shows a block diagram of a probabilistic filter determine swing, stance, and collision modes using joint encoder information according to some embodiments.

FIG. 5C shows an illustration of different modes used by the IMM-KF in several embodiments.

FIG. 5D shows a flowchart of a method for modifying a reference according to some embodiments.

FIG. 6 illustrates an example of a control system for a legged robot.

FIG. 7 illustrates the generation of the reference trajectory according to performance objective.

FIG. 8 illustrates a block diagram of a method for updating a state of the reference trajectory, according to some embodiments of the present disclosure.

FIG. 9 illustrates a block diagram of a method for updating the parameters associated with a reference trajectory related to a task.

FIG. 10 illustrates tracking the state of the reference trajectory, according to some embodiments of the present disclosure.

FIG. 11 illustrates parametrization of reference trajectories for a legged robot, according to some embodiments of the present disclosure.

FIG. 12 illustrates an example of the use of weighted basis function to define a parameter according to an embodiment.

FIG. 13 illustrates a table representing the encoding/decoding of parameters associated with a reference trajectory related to a task using basis function.

FIG. 14 illustrates a schematic configuration of a multi-legged robot, designed to navigate dynamic and uncertain environments using an advanced probabilistic control system, in accordance with some embodiments.

FIG. 15 shows a schematic of a probabilistic feedback controller for robot control using an interacting multiple-model (IMM) framework, in accordance with some embodiments.

FIG. 16 illustrates the control architecture of a quadrupedal robot leveraging probabilistic force estimation and adaptive control to enhance locomotion stability and responsiveness in dynamic environments, in accordance with some embodiments.

FIG. 17 shows a block diagram of the probabilistic force estimation framework using an Interacting Multiple-Model Kalman Filter (IMM-KF) for a quadrupedal robot, enabling simultaneous contact mode estimation and external force tracking.

FIG. 18 illustrates a flowchart of a method for implementing the interaction step, in accordance with some embodiments.

FIG. 19 illustrates a flowchart of a method for implementing the filtering step within the Interacting Multiple-Model Kalman Filter (IMM-KF) framework, in accordance with some embodiments.

FIG. 20 illustrates a flowchart of a method for implementing the probability update step within the Interacting Multiple-Model Kalman Filter (IMM-KF) framework, in accordance with some embodiments.

FIG. 21 illustrates a flowchart of a method for implementing the combination step within the Interacting Multiple-Model Kalman Filter (IMM-KF) framework, in accordance with some embodiments.

FIG. 23 illustrates a flowchart of a method for implementing the admittance motion control within a quadrupedal robot control system, in accordance with some embodiments.

### DETAILED DESCRIPTION

### Overview of the Contribution to the Art

This Overview is provided to introduce a selection of concepts in a simplified form that are further described below in the Detailed Description. This Overview is not intended to identify key features or essential features of the claimed subject matter, nor is it intended to be used as an aid in determining the scope of the claimed subject matter.

In the following description, for purposes of explanation, numerous specific details are set forth in order to provide a thorough understanding of the present disclosure. It will be apparent, however, to one skilled in the art that the present disclosure may be practiced without these specific details. In other instances, apparatuses and methods are shown in block diagram form only in order to avoid obscuring the present disclosure.

As used in this specification and claims, the terms “for example,” “for instance,” and “such as,” and the verbs “comprising,” “having,” “including,” and their other verb forms, when used in conjunction with a listing of one or more components or other items, are each to be construed as open ended, meaning that that the listing is not to be considered as excluding other, additional components or items. The term “based on” means at least partially based on. Further, it is to be understood that the phraseology and terminology employed herein are for the purpose of the description and should not be regarded as limiting. Any heading utilized within this description is for convenience only and has no legal or limiting effect.

Control of robotic systems often includes motion planning for generating a reference trajectory governing the control. Generating the reference trajectory is a challenging and computationally expensive task, especially in the presence of an uncertain and/or changing environment surrounding a robot. To address the uncertainty of the environment, a number of methods use sophisticated techniques for motion planning and control for tracking reference trajectories under uncertainty.

Some embodiments are based on using a probabilistic filter which, only using wheel encoders, detects when at least one of the legs of a legged robot are in contact with an obstacle in the environment different from walking on a surface. Subsequently, some embodiments generate a reflex motion as a reference trajectory to avoid said obstacle. The detection is done through a virtual force measurement dependent on the wheel encoder data and kinematics of the system, wherein the contact detection changes based on the environment. Some embodiments realize that only using wheel encoder data is cost efficient, as it avoids the addition of costly sensing onto the robot. Several embodiments of the disclosure allows to track and adjust the state of the reference trajectory itself by adapting some principles borrowed from tracking and adjusting the state of the robot.

For example, some control methods use probabilistic filters that track the state of the robot based on the change of the control inputs to the robot. Examples of such a filter includes a Kalman filter. Example embodiments parameterize the probabilistic filter on the state of the mode of the robot, e.g., swing, stance, collision, only using encoder information and the robot dynamics. Subsequently, one embodiment uses the virtual force measurement as a disturbance input to a controller to suppress the effect of such disturbances, in effect creating reference trajectory to track the state of the robot based on the changes in the environment. This tracking can be subjected to a performance objective which is imposed on the tracked state by either the prediction model of the filter, the measurement model of the filter, the control objective of the controller, or a combination thereof.

Advantages of the present disclosure include: tracking the reference trajectory satisfying the performance objective with respect to the environment allows to simplify the generation of the reference trajectory, use of legacy leg control policies, desynchronize modification of the reference trajectory from the control, etc. Further the use of probabilistic filters, such as a Kalman filter, can be effectively executed by an embedded processor as the structure of the probabilistic filter is simpler than the structure of the filter used for tracking the state of the robot due to the simplified prediction model lacking inertia of the motion model of the robot.

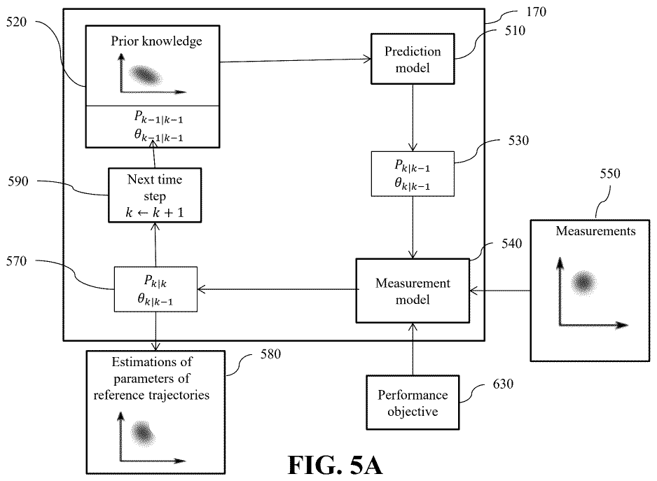

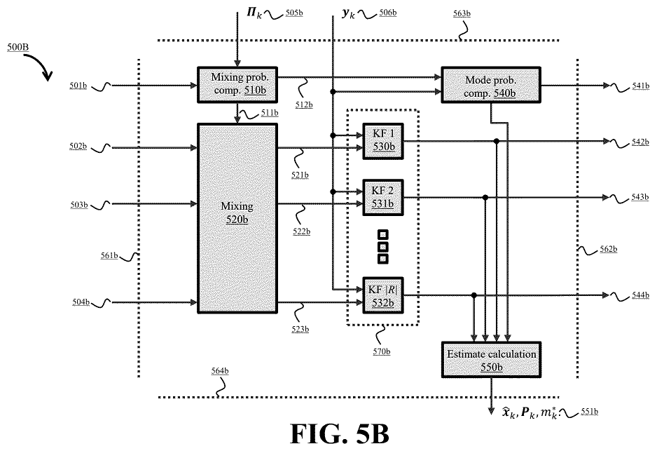

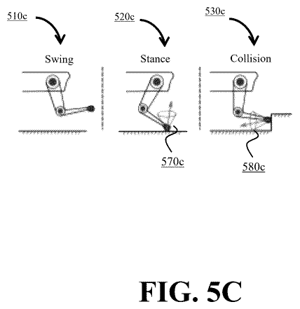

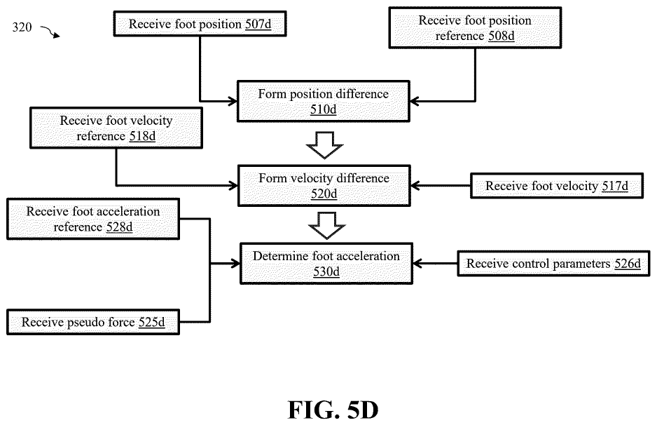

FIG. 5A through FIG. 5D illustrate a block diagram of a control system for controlling an operation of a legged robot, according to some embodiments of the present disclosure. Some embodiments are based on the recognition that an objective of the control system 100 is to control the legged robot 110 in engineered processes. To this end, the control system 100 may be operatively coupled to the legged robot 110. The control system 100 may include at least one processor 120, a transceiver 130, a memory 180 and a bus 140. The memory 180 may be embodied as a storage media such as RAM (Random Access Memory), ROM (Read Only Memory), hard disk, or any combinations thereof. For instance, the memory may store instructions that are executable by the at least one processor 120. The at least one processor 120 may be embodied as a single core processor, a multi-core processor, a computing cluster, or any number of other configurations. The at least one processor 120 may be operatively connected to the memory 180 and/or the transceiver 130 via the bus 140. According to an embodiment, the at least one processor 120 may be configured as a feedback controller 150, a reference trajectory generator 160, a reference modifier 165, and/or a probabilistic filter 170. Accordingly, the feedback controller 150, the reference trajectory generator 160 and the probabilistic filter 170 may be embodied within the single core processor, the multi-core processor, the computing cluster, or any number of other configurations. Alternatively, the feedback controller 150 may be embodied outside the control system 100 and may be in communication with the control system 100. In one configuration, the reference trajectory generators 160 and 165 may be operatively coupled to the feedback controller 150, which in-turn may be coupled to the legged robot 110. For example, the feedback controller 150 may be, but are not limited to, a model-predictive controller (MPC), a proportional integral derivative (PID) controller, an optimal controller, a neural network controller, or the like. The probabilistic filter 170 includes a Kalman filter such as but not limited to an interacting multiple-model Kalman filter (IMM-KF), and IMM extended KF (IMM-EKF), an IMM unscented Kalman filter (IMIM-UKF). The reference modifier may adjust the reference from 160 in response to the contact force of the environment estimated by the probabilistic filter 170.

According to an embodiment, the feedback controller 150 may be configured to determine a sequence of control inputs to control a set of actuators 190 of the legged robot 110. Further, controlling the actuators 190 of the legged robot 110 comprises coordinating the motors associated with each leg of the legged robot 110 to obtain a motion of the center of mass (CoM) of the legged robot 110. For example, the control inputs may be possibly associated with physical quantities such as voltages, pressures, forces, torques, or the like. In an example embodiment, the feedback controller 150 may determine the sequence of control inputs such that the sequence of the control inputs changes states of the legged robot 110 in order to perform a specific task, e.g., tracking a reference. Once the sequence of control inputs is determined, the transceiver 130 may be configured to submit the sequence of control inputs as an input signal 102 to the legged robot 110. As a result, the states of the legged robot 110 may be changed according to the input signal 102 to perform the specific task. For instance, the transceiver 130 may be a radio frequency (RF) transceiver, or the like.

Further, the states of the legged robot 110 may be measured using one or more sensors installed in the legged robot 110. The one or more sensors may send a feedback signal 104 to the transceiver 130. The transceiver 130 may receive the feedback signal 104. In an example embodiment, the feedback signal 104 may include a sequence of measurements corresponding to the sequence of the control inputs respectively. For instance, the sequence of measurements may be measurements of the states outputted by the legged robot 110 in accordance with the sequence of the control inputs. Accordingly, each measurement in the sequence of measurements may be indicative of a state of the legged robot 110 caused by a corresponding control input. Each measurement in the sequence of measurements may be possibly associated with the physical quantities such as currents, flows, velocities, positions, and/or the like. In this way, the control system 100 may iteratively submit the sequence of control inputs and receive the feedback signals. In an example embodiment, in order to determine the sequence of control inputs in a current iteration, the control system 100 uses the feedback signal 104 that includes the sequence of measurements indicating current states of the legged robot 110.

In order to determine the sequence of control inputs in the current iteration, the feedback controller 150 may be configured to determine, at each control step, a current control input for controlling the legged robot 110 based on the feedback signal 104 including a current measurement of a current state of the legged robot 110. According to an embodiment, to determine the current control input, the feedback controller 150 may be configured to apply a control policy. As used herein, the control policy may be a set of mathematical equations that map all or a subset of states of the legged robot 110 to the control inputs. The mapping can be analytical or based on a solution to an optimization problem. In response to applying the control policy, the current measurement of the current state may be transformed into the current control input, based on the feedback controller 150 and values of parameters of reference trajectories in the reference trajectory generator 160. As used herein, the parameters of the reference trajectories may be a desired walking speed of the legged robot 110, a desired step height of a foot of the legged robot 110, a desired rotational velocity of the legged robot 110, and the like. Notably, the parameters of the reference trajectories should not be confused with the control inputs, which are outputs of the control policy, or with the states of the legged robot 110.

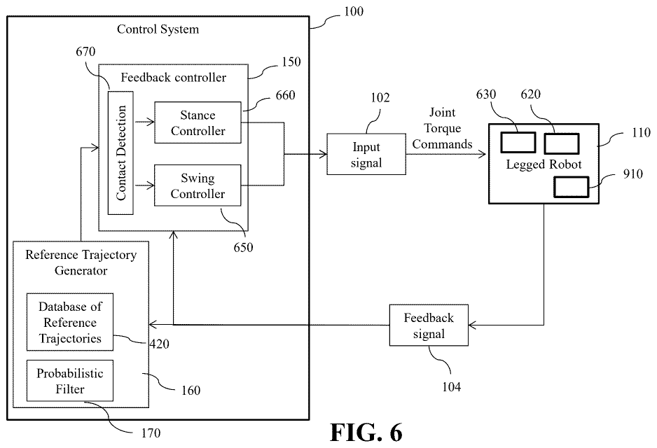

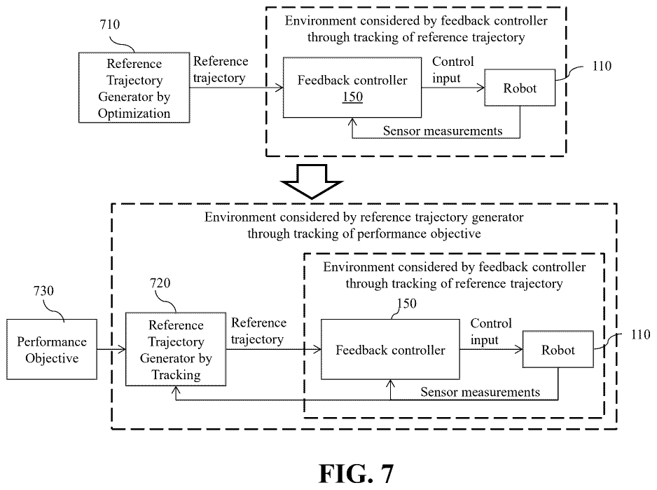

FIG. 6 illustrates a probabilistic filter 170 estimating a state of a legged robot 110 according to some embodiments of the present disclosure. Accordingly, the probabilistic filter 170 accepts a feedback signal 104, wherein the feedback signal 104 includes a state of the legged robot 110 and/or a state of the environment in which the legged robot 110 is operating. The probabilistic filter 170 may accept one or a combination of the state of the legged robot 110, which may be a current state of the legged robot 110, along with the state of the environment. In some embodiments, the feedback signal 104 is a set of virtual measurements, which provide information about the state of the environment of the legged robot. For instance, one embodiment realizes that to measure the contact force of a legged robot, a force sensor needs to be mounted in connection to the leg under contact. However, by using the joint encoder information and the robot dynamics, virtual measurements of the momentum of the robot and the contact force of the robot can be calculated.

The feedback signal 104 is processed by a prediction model 210 and a measurement model 220 of the probabilistic filter 170 to estimate a state 250 of legged robot and environment 230. The prediction model 210 is a model modeling the time evolution of the state of the robot from one time step to the next time step and is subject to process noise and the measurement model 220 is subject to measurement noise. The probabilistic filter 170 updates the current state 250 of the legged robot based on the feedback signal using a measurement model testing the performance objective subject to the measurement noise. For example, the prediction model 210 predicts a current state of the contact force of the environment 230 based on a previous state of the contact force of the environment 230 and the measurement model 220 updates the current state of the reference trajectory based on the current state of the legged robot 110 and the state of the environment in which the legged robot is operating. The prediction model 210 may be a model subject to process noise that is configured to predict the state of the reference trajectory within a variance defined by the process noise.

In one embodiment the probabilistic filter 170 includes an IMM-KF. In various embodiments, the state includes a generalized momentum of the robot and an external force acting upon the at least one leg of the robot. The IMM-KF is used to estimate adjust the pre-computed reference trajectories to the current task and/or the current environment using a reference modifier 165 in response to the state 250. The Kalman filter is a process (or a method) that produces estimates of unknown variables using a series of measurements observed over a time period, containing statistical noise and other inaccuracies. Indeed, these produced estimates of the unknown variables may be more accurate than an estimate of an unknown variable produced using a single measurement. The Kalman filter produces the estimates of the unknown variables by estimating a joint probability distribution over the unknown variables. The Kalman filter is a two-step process, which includes a predicting step and an updating step. In the predicting step, the Kalman filter uses a prediction model to predict the current states along with their uncertainties governed by a process noise. For instance, the prediction model may be artificially designed such that the prediction model is subjected to the process noise for reducing the uncertainties in the states, while predicting the current states. Indeed, the predicted current states may be represented by the joint probability distribution over the current states.

FIG. 7 illustrates a flow chart of a method 300 for adjusting a reference trajectory in response to estimating an external contact force for the legged robot 110 according to some embodiments of the present disclosure. All types of robots are required to perform continuous tasks that require the reference trajectory that is used in a controller to be continuously re-computed or adapted to a current task and a current environment of the robot. The task includes such as, but not limited to, combination of walking straight, turning right or left, climbing stairs, high-stepping gait, trotting, etc. Accordingly, the value of the external force 310 estimated by the probabilistic filter 170 is used to iteratively modify the reference trajectory 320 based on a combination of the external force and a performance objective. The performance objective comprises one or a combination of requirements for (i) a desired foot clearance/step height of the legged robot, (ii) a desired walking speed of the legged robot, (iii) a desired turn rate of the legged robot, (iv) a desired stair height for climbing stairs, (v) a desired energy consumption of the legged robot, (vi) a desired foot slippage of the legged robot, (vii) a desired ground reaction force of the legs of the legged robot, and (viii) a desired collision free movement of the legs of the legged robot.

The method 300 begins with receiving a first task 305. For example, the task for the robot to turn left is received by the control system 100. In response to receiving the first task 305, the probabilistic filter 170 is initialized with parameters associated with a current state of the legged robot 110.

Based on this initialization, the probabilistic filter 170 recursively estimates a value of an external force 310, to modify the value of the reference trajectory 320 related to the first task is done.

Further, the feedback signal 104 may be received which indicates a change of a state of the legged robot 110 moving according to the reference trajectory. In response to receiving of the feedback signal 104, the probabilistic filter 170 is executed iteratively to track the state of the legged robot 110. Further, checking 330 is done to identify whether the performance objective is satisfied or not with respect to the state of the legged robot 110 to update the reference trajectory 325. If the performance objective is satisfied, then the method 300 proceeds with updating the reference trajectory until receiving 340 a second task, else the method proceeds directly to receiving the second task.

Also, the reference trajectory is updated by decoding the updated parameters of the probabilistic filter 170. Further, this updated trajectory is then used to generate the control inputs, such as the input signal 102, for the actuators 190 of the legged robot 110. Then, the actuators 190 are controlled as per the corresponding control inputs.

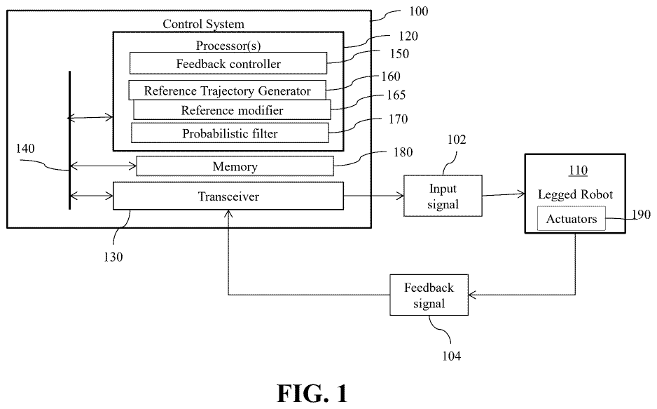

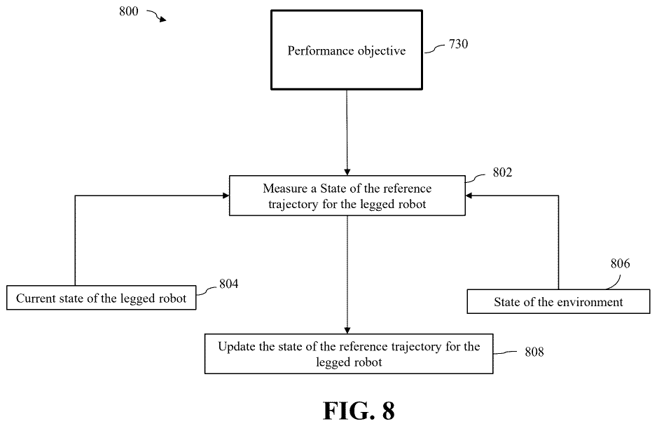

FIG. 8 illustrates a block diagram of a control system for initiating and controlling an operation of a legged robot 110, according to some embodiments of the present disclosure. The control system 100 as discussed above with reference to FIG. 1 is in communication with a supervisory controller 410 and has access to a database 420. The control system 100 receives a task from a supervisory controller 410. The task may also be received from other sources, such as but not limited to, external sensors 430, voice command or a remote call. The task includes either one or a combination of walking, turning right or left, climbing stairs, high-stepping gait, trotting, etc. The supervisory controller 410 can be external to the control system 100 or in-built within the control system 100 or within the legged robot 110. Further, upon receiving the task, the control system 100 selects predetermined parameters from the database 420 based on the task and initializes the parameters of the probabilistic filter 170 with the selected predetermined parameters. The database 420 can be external to the control system 100 or in-built within the control system 100. The parameters can be predetermined for the task and encode the reference trajectory including a combination of different trajectories for coordinated motion primitives of different actuators of the legged robot moving the legged robot according to the task. The parameters include one or multiple parameters of the reference trajectory such as (i) a foot clearance/step height of the legged robot, (ii) a walking speed of the legged robot, (iii) a turn rate of the legged robot, and (iv) a stair height for climbing stairs. The predetermined or pre-computed, or online calculated parameters are selected based on the performance objective such that the selected parameters are closest to some norm of the required target value.

For example, given a number of predetermined reference trajectories, the predetermined parameters of the reference trajectory that yields the lowest cost may be selected. The parameters of the chosen pre-computed reference trajectory may then be used and further adapted to satisfy the task and the required target values. For example, the parameters of the pre-computed reference trajectory associated with the lowest cost may be used to initialize the probabilistic filter 170. The requirement target value may be compared with the pre-computed reference trajectories in the database of reference trajectories.

The pre-computed reference trajectories in the database of reference trajectories may have requirement values associated, which may be used to compare the pre-computed reference trajectories with the required target value and determine which pre-computed reference trajectory fits the current task and its required target value most closely. For example, a squared 2-norm may be computed between the requirement target value and the associated requirement value of the pre-computed reference trajectories in the database of reference trajectories. Then, the pre-computed reference trajectory may be chosen that yields the smallest squared 2-norm.

In some embodiments the adapted reference trajectory that is currently utilized by the control system 100 is continuously compared with the required value of the pre-computed reference trajectories in the database 420 of reference trajectories. For example, the squared 2-norm may be computed between the required target value and the adapted reference trajectory currently employed by the control system 100. Further, the squared 2-norm may be computed between the required target value and the pre-computed reference trajectories in the database of reference trajectories. The adapted reference trajectory may be replaced by another pre-computed reference trajectory if the squared 2-norm may be lower. One advantage of continuously comparing the adapted reference trajectory with the pre-computed reference trajectories is that if the requirement target value shifts, it may be more efficient to switch the reference trajectory and re-initialize the tracking algorithm with a new set of parameters associated with the newly selected pre-computed reference trajectory.

In other embodiments, the reference trajectory 325 determined by the reference generator 160 is determined online, e.g., using sampling-based planners or optimization-based planners.

It is to be understood that the reference generator 160 is different from the reference modifier 165, as the reference modifier adapts the reference from the reference trajectory generator based on the estimation of the environment.

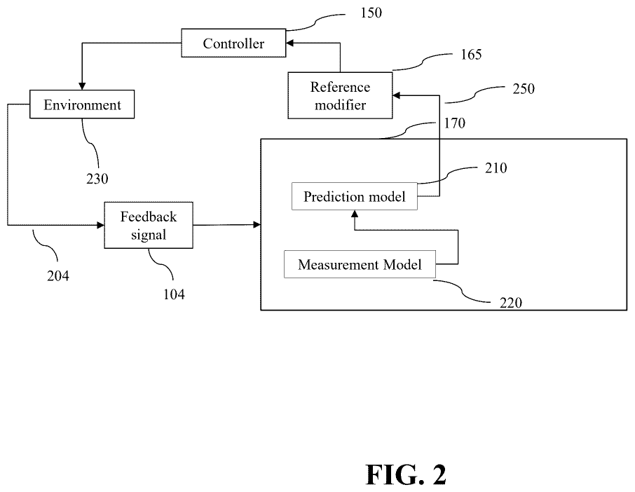

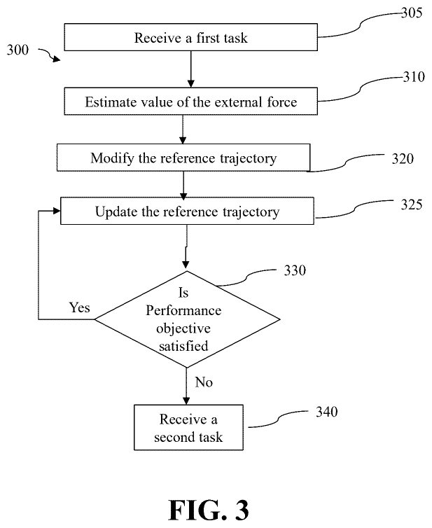

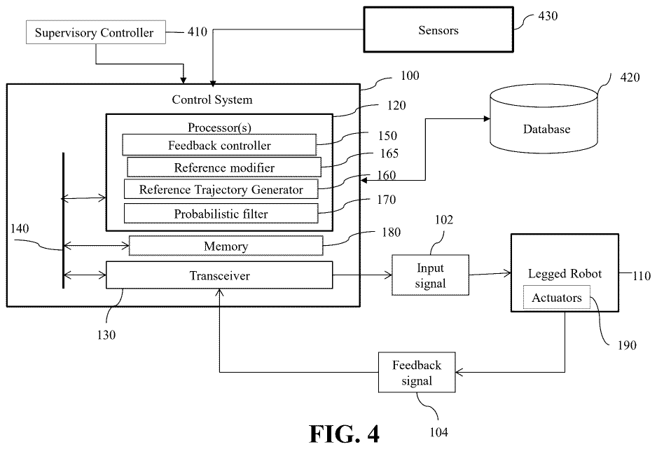

FIG. 5A illustrates the probabilistic filter 170, for example the Kalman filter for estimating the external force, according to some embodiments of the present disclosure. Hereinafter, for the purpose of description of FIG. 5A, the probabilistic filter 170 would be interchangeably referred to as the KF or the IMM-KF170, without deviating from the scope of the present disclosure. According to one embodiment, the state of the IMM-KF 170 is defined by the mode the KF estimates. To this end, it is an objective of the Kalman filter 170 to iteratively estimate the mode of the legged robot. In an example embodiment, the Kalman filter 170 may iteratively estimate the mode of the legged robot, using a prediction model 510 and a measurement model 540. The prediction model 510 is equivalent to the prediction model 210 shown in FIG. 2, and the measurement model 540 is equivalent to the measurement model 220 shown in FIG. 2, without limiting the scope of the present disclosure. For instance, the prediction model 510 and the measurement model 540 may be artificially designed.

To produce the estimate of the mode n a current iteration (e.g., at a time step k), the prediction model 510 may be configured to predict values of the generalized momentum and external force using a prior knowledge 520 of the mode. For instance, the prior knowledge 520 mode may be produced at a previous iteration (e.g., at a time step k−1). The prior knowledge 520 of the mode may be a joint probability distribution (or a Gaussian distribution) over the modes at the previous iteration. The joint probability distribution over the modes at the previous iteration can be defined by a mean, θ_{k-1|k-1}, and a variance (or a covariance), P_{k-1|k-1}, computed at the previous iteration. For instance, the joint probability distribution at the previous iteration may be produced based on a joint probability distribution that was produced in a past previous iteration (e.g. at time step k−2).

According to an embodiment, the values of the modes predicted in the current iteration may also be a joint probability distribution 530 (or a Gaussian distribution 530). For instance, the output of the prediction model 510 may be the joint probability distribution 530, when the prediction model 510 is configured to predict states of the legged robot, each state distinct for a particular mode. Alternatively, the output of the prediction model 510 may be the Gaussian distribution 530 when the prediction model 510 is configured to predict a single state. For instance, the joint probability distribution 530 may be defined by a mean, θ_{k|k-1}, and a variance (or a covariance) P_{k|k-1}, computed in the current iteration.

FIG. 5B shows a block diagram of a probabilistic filter determine swing, stance, and collision modes using joint encoder information according to some embodiments. The probabilistic filter is implemented using interactive mixture methods. The information propagates from left to right in time, and from input to output in the top of the schematic to the bottom of the schematic. Information that is necessarily stored in memory over the transition in time step (k−1) [symbol] k and the transition k [symbol] (k+1) are indicated by the dotted lines 561b and 562b, respectively. This information includes at least the estimates from each particle in the filter bank 570b and the mode probabilities. In some embodiments, the estimates are represented by a Gaussian distribution with a mean and covariance for each particle here denoted

$${\{ ( {m}_{k \vert k}^{m} , {P}_{k \vert k}^{m} ) \}}_{m = 1}^{\vert R \vert}$$

and a mode probability associated with each particle

$${\{ {w}_{k \vert k}^{m} \}}_{m = 1}^{\vert R \vert} .$$

In this embodiment, the mean and covariance are shown for the first two and the last particle with at the transition (k−1) [symbol] k in 502b, 503b, 504b and the transition k [symbol] (k+1) in 542b, 543b, 544b, and the set of mode probabilities are shown in 501b for the transition (k−1) [symbol] k in 501b and k [symbol] (k+1) in 541b, respectively.

Similarly, the algorithm takes two inputs per time step, indicated as crossing the input line 563b, the measurement 406b and the transition probability matrix 505b. The transition probability matrix is a square matrix containing a number of rows equal to the number of models in the filter bank 570b. The output of the algorithm is an estimate of the state, which in this embodiment is represented by a Gaussian distribution with a mean and a covariance 551b. In addition, the method outputs the most likely model to have given rise to the measurements sampled at a time k denoted

$${m}_{k}^{*} .$$

In some embodiments, such model is associated with a distinct mode of the movement of the legged robot, e.g., the model 530b is unique for stance mode, the model 531b is unique for swing mode, and the model 532b is unique for contact mode.

The estimator takes the mode probabilities and transitions these using the transition probability matrix using a simple multiplication in the computation of the mixing probabilities 510b. This results in a set of mixing probabilities

$${\{ {\tilde{w}}_{k \vert k}^{ij} \}}_{i = 1 , j = 1}^{\vert R \vert , \vert R \vert}$$

511b, 512b that are used to mix the estimates of the particles provided as input to the method 502b, 503b, 504b. In one embodiment, these mixing probabilities are computed by

$${\tilde{w}}_{k - 1 \vert k - 1}^{ij} = \frac{{[ {\prod }_{k} ]}_{ji}}{{{\sum }_{l = 1}^{\vert R \vert} [ {\prod }_{k} ]}_{li} {w}_{k - 1 \vert k - 1}^{m}}$$

Based on the mixing probabilities a set of mixed estimates are computed 521b, 522b, 523b. The mixing step is conducted as follows:

$${\hat{x}}_{k - 1 \vert k - 1}^{0 i} = {\sum }_{j = 1}^{\vert R \vert} {\tilde{w}}_{k - 1 \vert k - 1}^{ji} {\hat{x}}_{k - 1 \vert k - 1}^{j}$$

$${\hat{P}}_{k - 1 \vert k - 1}^{0 i} = {\sum }_{j = 1}^{\vert R \vert} {\tilde{w}}_{κ - 1 \vert 1 - 1}^{ji} [ {\hat{P}}_{k - 1 \vert k - 1}^{i} + ( {\hat{x}}_{k - 1 \vert k - 1}^{j} - {\hat{x}}_{k - 1 \vert k - 1}^{0 i} ) {( {\hat{x}}_{k - 1 \vert k - 1}^{j} - {\hat{x}}_{k - 1 \vert k - 1}^{0 i} )}^{T} ]$$

The Gaussian density

$$N ( {\hat{x}}_{k - 1 \vert k - 1}^{0 i} , {\hat{P}}_{k - 1 \vert k - 1}^{0 i} )$$

serves as the prior for a Kalman filter prediction and update done in each of the particles 530b, 531b, 532b, producing estimates

$$N ( {\hat{x}}_{k \vert k}^{0 i} , {\hat{P}}_{k \vert k}^{0 i} ) .$$

It is understood that these updates can be done using explicit approximations of linear maps to any nonlinearities in the estimation model associated with each particle in the filter bank 570b or using statistical regression techniques and moment matching as described in relation to FIG. 5A.

The innovation error in the Kalman filter updates is used to update the mode probabilities of the particles 540b. Let L (m; k) denote the Gaussian likelihood of the innovation error in the Kalman filter update of the mth particle at a time step k. Then, in one embodiment the mode probability weight update is done according to this Gaussian measurement likelihood, taking the mixing probabilities 512b as input and producing updated mode probabilities 541b as follows

$${w}_{k \vert k}^{i} = \frac{L ( i ; k ) {{\sum }_{j = 1}^{\vert R \vert} [ {\prod }_{k} ]}_{ji} {w}_{k - 1 \vert k - 1}^{j}}{{\sum }_{j = 1}^{\vert R \vert} L ( l ; k ) {{\sum }_{j = 1}^{\vert R \vert} [ {\prod }_{k} ]}_{jl} {w}_{k - 1 \vert k - 1}^{j}}$$

From the updated mode probabilities, an estimate is computed 550b. In one embodiment, this estimate is found using the law of total probability to combine a portion of each particle based on its mode probability in computing the estimate.

$${\hat{x}}_{k} = {\sum }_{j = 1}^{\vert R \vert} {w}_{k \vert k}^{i} {\hat{x}}_{k \vert k}^{i}$$

$${P}_{k} = {\sum }_{i = 1}^{\vert R \vert} {w}_{k \vert k}^{i} [ {\hat{P}}_{k \vert k}^{i} + ( {\hat{x}}_{k} - {\hat{x}}_{k \vert k}^{i} ) {( {\hat{x}}_{k} - {\hat{x}}_{k \vert k}^{i} )}^{T} ]$$

In this step, the most likely model is computed with respect to the updated mode probabilities

$${\{ {w}_{k \vert k}^{m} \}}_{m = 1}^{\vert R \vert}$$

computed in 540b. Specifically, the most likely model is computed as

$${m}_{k}^{*} = {argmax}_{m} ( {\{ {w}_{k \vert k}^{m} \}}_{m = 1}^{\vert R \vert} )$$

FIG. 5C shows an illustration of different modes used by the IMM-KF in several embodiments. FIG. 5C shows the force measurement models for swing 510c, stance 520c, and collision 530c contact modes. Some embodiments are based on the understanding that depending on the mode of the robot, the contact force and consequently the measurement models and dynamical models will differ between the different modes. Some embodiments leverage that to determine robot modes based on the internal encoder information only.

Some embodiments utilize that the robot dynamics for a legged robot can be written as a function of the joint variables as

$$M ( q ) \ddot{q} + C ( q , \dot{q} ) + g ( q ) + {τ}_{f} = {τ}_{ext} + {τ}_{m} ,$$

where M is the mass matrix, C(q, \dot{q}) is the Christoffel's symbol generating the Centrifugal force and Coriolis force, q is the joint angle, g is the gravitational acceleration, τ_{f} is the joint friction term, τₘ is the joint torque induced by the motors, and τₑₓₜ is the external joint torque induced by the ground reaction forces. The external joint torque is

$${τ}_{ext} = {\sum }_{j = 1}^{{n}_{f}} {J}_{{c}_{j}}^{T} ( q ) {ℱ}_{ext , j} ,$$

where J_{cj}(q) and [symbol] _{ext,j} are the geometric contact Jacobian and external wrenches applied at the jth foot, respectively, n_{f} is the number of feet of the robot. The external wrench includes both the externa force and moment.

Some embodiments make use of the generalized momentum (GM) p=M(q)\dot{q} as a pseudo, or virtual, measurement in the IMM-KF, where: p represents generalized momentum, M(q) is the mass matrix, \dot{q} denotes joint velocity

Some embodiments are enabled by the assumption that during the collision phase, the external force applied to one foot has negligible effects on the GM of the floating base and the other legs. This assumption is reasonable before
a detrimental crash occurs, especially when an advanced balancing controller is deployed simultaneously. It is important to note that while the proposed algorithm can be applied to the full model, this would result in exponentially more contact modes and significantly higher computational complexity.

In some embodiments, the GM is combined with a disturbance observer for contact forces, wherein the robot dynamics can be written as a mode-dependent dynamics,

$$[ \begin{matrix}\dot{p} \\ {\dot{f}}_{ext}\end{matrix} ] = [ \begin{matrix}{0}_{3 \times 3} & {S}^{( k )} {J}^{T} \\ {0}_{3 \times 3} & {A}_{f}\end{matrix} ] [ \begin{matrix}p \\ {f}_{ext}\end{matrix} ] + [ \begin{matrix}{I}_{3} \\ {0}_{3 \times 3}\end{matrix} ] u + [ \begin{matrix}{ω}_{p} \\ {ω}_{f}\end{matrix} ] ,$$

where kϵ{1, . . . , M} is the mode. The matrix A_{f}, usually defined by a small negative definite diagonal matrix, governs the dynamics of the external force to mitigate the potential constant offset introduced by the disturbance. In one embodiment, M=3 defined by swing mode k=1, stance mode k=2, and collision mode k=3, with the selection matrix

$${S}^{( k )} = \{ \begin{matrix}0 & if k = 1 \\ I & otherwise\end{matrix} .$$

In one embodiment, the system model differentiates between the swing mode and other contact modes. For the
swing mode, zero external force is assumed, which is not factored into the prediction of the GM.

Because of the different modes and the contact differentiation between modes as referred to in FIG. 5C, the measurement model will be different for different modes. To improve performance, one embodiment introduces an additional virtual measurement to better distinguish between different contact modes. The measurement model is

$$y = [ \begin{matrix}{I}_{N} & {0}_{N \times 12} \\ {0}_{12 \times N} & {I}_{12 \times 12}\end{matrix} ] [ \begin{matrix}p \\ {f}_{ext}\end{matrix} ] + [ \begin{matrix}{υ}_{p} \\ {υ}_{f}\end{matrix} ] ,$$

which is a measurement model of two virtual measurements obtained through the joint encoder information and the robot dynamics, with measurement noise

$$[ \begin{matrix}{υ}_{p} \\ {υ}_{f}\end{matrix} ] .$$

Consequently, although a direct force measurement is not available due to the absence of a force sensor, a hypothetical pseudo-force can still be computed given the explicit contact mode.

For instance, one embodiment assumes zero contact force for the swing mode, which is because the leg of the root is in free swing without collision when in swing mode. On the other hand, for the two other modes one embodiment combines the robot dynamics M(q)\ddot{q}+C(q, \dot{q})+g(q)+τ_{f}=τₑₓₜ+τₘ and the contact constraint J\ddot{q}+\dot{J}\dot{q}=0. Subsequently, it is possible after some simplifications to express the pseudo force as f_{pseudo}=−(JM⁻¹J^{T})^{†}(JM⁻¹τₘ+\dot{J}\dot{q}) or f_{pseudo}=−(J^{T})^{†}τₘ, if assuming that the joint velocity is zero during contact.

In some embodiments, as shown in FIG. 5C, the shapes of the friction cones are defined separately for the stance 570c and collision 580c mode, given prior assumptions on the potential terrains. In some embodiments, the measurement noise is selected to be dependent on if the pseudo force vector is in such friction cone.

Some embodiments are based on the recognition that a collision detection can be used to modify a reference of the reference trajectory.

FIG. 5D shows a flowchart of a method 320 for modifying a reference according to some embodiments. First, the method receives the foot position 507d and nominal reference foot position 508d, to form 510d a position difference. Next, the method receives the foot velocity 517d and the foot velocity reference 518d to form a velocity difference between desired foot position velocity and current foot position velocity. Using the position difference and velocity difference, the method receives the foot acceleration difference 528d, the calculated pseudo force 525d, and control parameters 526d, and determines 530d a modified foot acceleration in response to the external force 525d.

In some implementations, such reference modification is implemented using an admittance control \ddot{r}=M⁻¹(\hat{f}ₑₓₜ−D(\dot{r}−\dot{r}_{d})−K(r−r_{d}))+\ddot{r}_{d},
where the scalars r and r_{d} are the current desired foot position in the forward or lateral direction. Further, the parameters M, D, and K are the virtual mass, damping, and stiffness coefficients of the admittance control, which can be determined a priori or during runtime.

In some embodiments the vertical position of the foot, i.e., foot height, is adjusted upon detecting a collision of a leg. If the swing foot is in the first half of its swing duration, as determined by the gait scheduler, the original step height is increased by a fixed amount above the current foot height at the moment of collision.

FIG. 6 illustrates an example of a control system for a legged robot, according to some embodiments of the present disclosure. In order to control the motion of the legs of the legged robot 110, the control system 100 sends the input signal 102, which may be a torque command to electric motors of the legged robot 110. For example, the legged robot 110 with four legs may have three electric motors per leg, which include an electric motor for actuating a knee joint 610, an electric motor for actuating a hip joint 620, and an electric motor for actuating a thigh joint 630. The electric motor for actuating the knee joint 610 may control the flexion and extension of the knee joint. The electric motor for actuating the hip joint 620 may control the abduction and the adduction of the leg. The electric motor for actuating the thigh joint 630 may control the flexion and extension of the leg. In this example, the control system 100 sends twelve electric motor commands for the four legs of the legged robot 110. The control system 100 may include a stance controller 660, a swing controller 650, and a contact detection 670. The stance controller 660 stabilizes the legged robot 110 using the legs, which are in contact with the ground. The swing controller 650 moves the legs that are not in contact with the ground in order to correct the legged robot's position and/or to achieve forward progress. The stance controller 660 and the swing controller 650 may be designed to follow reference trajectories computed using the reference trajectory generator 160 as closely as possible. The feedback signal 104 controls the operation of the stance controller 660 and the swing controller 650 such that each of the stance controller and the swing controller generate torque commands for the operation of the legged robot, based on the feedback signal 104. The feedback signal 104 is accepted in response to detecting a new touch with a surface by at least one leg of the legged robot 110. For example, one of the four legs of the legged robot touches a surface or terrain associated with the ground that requires stabilization of the legged robot 110. As a result the feedback signal 104 is accepted from the new touch of the leg of the legged robot 110. Further, the current state of the reference trajectory of the legged robot 110 is updated and the reference trajectory generator 160 generates an updated reference trajectory. The updated reference trajectory generated by the reference trajectory generator 160 leads to generation of new or updated torque commands by the stance controller 660 and the swing controller 650 for the operation of the legged robot 110, to follow the updated reference trajectory. In this manner, the feedback signal 104 is configured to control the operation of the stance controller 660 and the swing controller 650 to generate the (updated) torque commands, so that the legged robot 110 is able to follow the updated reference trajectory.

In some embodiments, a database of reference trajectories 410 is used to store pre-computed reference trajectories in the memory. The pre-computed reference trajectories may include walking patterns of the legged robot 110 at different walking speeds, different turn radii, and the like. In some embodiments, the probabilistic filter 170, for example an IMM-KF is utilized to modify the reference command in response to the collision estimation of the IMM-KF. One advantage of adjusting the pre-computed reference trajectories to the current task and/or the current environment is to control the legged robot 110 more accurately with a limited amount of the pre-computed reference trajectories. Hereinafter, the pre-computed reference trajectories refer to reference trajectories that are stored in the database of reference trajectories 410.

The stance controller 660 may be a model predictive controller (MPC), which aims at following a reference trajectory for the legged robot's CoM. The MPC may compute reaction forces of the legs that are in contact with the ground,

$${min}_{x , f} {\sum }_{k = 0}^{N} {‖ {x}_{k} - {x}_{k , ref} ‖}_{Q} + {‖ {f}_{k} ‖}_{R}$$

$$\begin{matrix}subject to & {f}_{k , min} \leq {f}_{k , z} \leq {f}_{k , max} - μ {f}_{k , z} \leq \vert {f}_{k x} \vert \leq μ {f}_{k , z} - μ {f}_{k , z} \leq \vert {f}_{k , y} \vert \leq μ {f}_{k , z} {x}_{k + 1} = A {x}_{k} + B {f}_{k} {D}_{k} {f}_{k} = 0\end{matrix} , \qquad ( 1 )$$

$$with the state$$

$${x}_{k} = [ \begin{matrix}{Θ}_{k} \\ {r}_{k} \\ {ω}_{k} \\ {v}_{k}\end{matrix} ] , \qquad ( 2 )$$

where Θₖϵ [symbol] ³ is the legged robot's orientation, rₖϵ [symbol] ³ is the CoM base position, ωₖϵ [symbol] ³ is the angular velocity, vₖϵ [symbol] ³ is the linear velocity, μϵ [symbol] is the friction coefficient, Aϵ [symbol] ^{12×12} and Bϵ [symbol] R^{12×12} are the dynamic matrices (for state propagation), Dₖ is a force selection matrix originating from the contact detection 670 (selecting forces that are not in contact to be equal to zero), and Q and R are diagonal positive semi-definite cost matrices. The joint torques (which are the input to the torque-controlled electric motors) may then be obtained using the forces fₖ resulting from the MPC (1) as

$${τ}_{i , k} = {{J}_{i , k} ( {R}_{b , i , k}^{w} )}^{T} ( - {f}_{i , k} ) , \qquad ( 3 )$$

where f_{i,k}ϵ [symbol] ³ is the force vector associated with leg i as subset of fₖϵ [symbol] ¹², and

$${R}_{b , i , k}^{w} ∈ {ℝ}^{3 \times 3}$$

is the rotation matrix from world to body frame of leg i at time step k. For example, the computed torque τ_{1,k}ϵ [symbol] ³ is the vector that includes the three commands for the electric motors of the first leg, i.e., for actuating the knee joint 610, for actuating the hip joint 620, and for actuating the thigh joint 530. The stance controller 660 may be executed at every sampling time step k, i.e., the torque commands may be re-computed at every sampling time step k.

The swing controller 650 may be based on a proportional feedback gain and a derivative feedback gain. The swing controller 650 aims at following reference trajectories for the legs defined by the sequence of positions

$${P}_{i , k , ref}^{b} ,$$

velocities

$${v}_{i , k , ref}^{b} ,$$

and accelerations

$${a}_{i , k , ref}^{b} ,$$

in the body frame, for each leg i. The swing controller 650 may use a model of the kinematics of each leg given by a Jacobian, and may use a proportional gain and a derivative gain,

$${τ}_{i , k} = {J}_{i , k} [ {K}_{p} ( {p}_{i , k , ref}^{b} - {p}_{i , k}^{b} ) + {K}_{d} ( {v}_{i , k , ref}^{b} - {v}_{i , k}^{b} ) + {Λ}_{i} ( {a}_{i , k , ref}^{b} ) ] + {V}_{i , k} {\dot{q}}_{i , k} + {G}_{i , k} , \qquad ( 4 )$$

where τ_{i,k}ϵ [symbol] ³ is the joint torque, q_{i,k}ϵ [symbol] ³ and \dot{q}_{i,k} E ϵ [symbol] ³ are the current joint position and velocity of foot i, J_{i,k} is the foot Jacobian, Kₚϵ [symbol] ^{3×3} and K_{d}ϵR^{3×3} are the proportional and derivative (PD) gain matrices (3×3 diagonal positive semi-definite), V_{i,k}ϵ [symbol] ^{3×3} is the torque due the coriolis and centrifugal forces, G_{i,k}ϵ [symbol] ³ is the torque due to gravity, and Λᵢϵ [symbol] ^{3×3} is the operational mass matrix. The swing controller 650 may be executed at every sampling time step k, i.e., the torque commands may be re-computed at every sampling time step k.

In such an exemplary feedback control system, the torque commands τ_{i,k} for all electric motors are thus computed either by the stance controller 660 (1) or the swing controller 650 (4), with the objective of tracking the reference trajectory for the legged robot's CoM and the reference trajectories for the legs. Thus, the feedback control system can be summarized as having the states of the legged robot 110 and the reference trajectories as inputs and the torque commands as outputs,

$${τ}_{i , k} = CTRL ( {z}_{k} , {z}_{k , ref} , {z}_{k + 1 , ref} , … , {z}_{k + N , ref} ) , \qquad ( 5 )$$

where zₖ denotes a vector of all states of the legged robot 110 and z_{k,ref}, z_{k+1,ref}, . . . , z_{k+N}_{_{z}}_{,ref} denote the reference trajectories for such states for times k, k+1, . . . , k+N. For example, a different feedback control system with the same inputs and the same outputs, but with a different internal structure, is joint position control.

In some embodiments, when a collision is detected, the estimated external force is applied to the swing leg in the dynamical prediction model of the MPC. Doing in such a manner allows the MPC to account for disturbances caused by unexpected collisions, thereby enhancing the robot's balancing capabilities.

FIG. 7 illustrates the generation of the reference trajectory according to performance objective, according to some embodiments of the present disclosure. In some previous systems, the reference trajectories are generated using optimization 710, wherein only the environment is considered by the feedback controller 150. However, in an embodiment of the present disclosure the reference trajectory generator tracks a performance objective 730 besides considering the environment for generating the reference trajectories thereby improve accuracy of the control. In the present scenario, the reference trajectory generator by tracking 720 includes states that are used to generate reference trajectories. The states of the reference trajectory generator by the tracking 720 may be different than the states from the legged robot 110. For example, the states of the reference trajectory generator may include a walking speed of the legged robot 110, a foot clearance of the legged robot 110, a turning rate or turning angle of the legged robot 110, and the like. The states of the reference trajectory generator may then be used to generate the reference trajectory for the feedback controller 150 to follow.

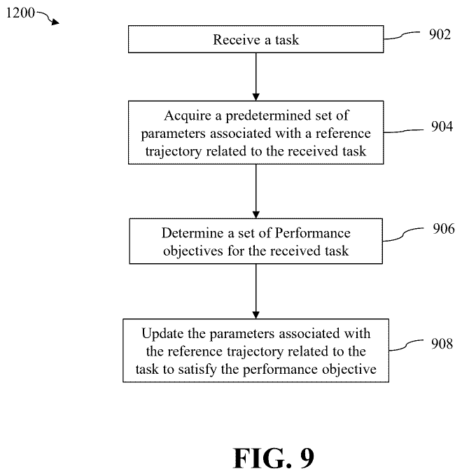

FIG. 8 illustrates a block diagram of a method 800 for updating a state of the reference trajectory, according to some embodiments of the present disclosure. Updating 808 the state of reference trajectory of the legged robot 110 includes measuring 802 a state of the reference trajectory, applying a feedback signal relating to a current state 804 of the legged robot 110 and a state of the environment 806 on the predicted state 802 to get an updated state 808 of the reference trajectory. Further, the updating 808 of the state is subject to the performance objective 730. This is further explained in conjunction with FIG. 9.

FIG. 9 illustrates a block diagram of a method 900 for updating the parameters associated with a reference trajectory related to a task. The method 900 includes receiving 902 a task to be performed by the legged robot 110 using a predetermined set of parameters associated with a reference trajectory related to the received task.

The method 900 further includes determining 906 a set of performance objectives, such as the performance objective 730, for the received task and updating 908 the parameters associated with the reference trajectory related to the task to satisfy the performance objective 730. For example, the performance objective 730 may include one or a combination of requirements for (i) a desired foot clearance/step height of the legged robot, (ii) a desired walking speed of the legged robot, (iii) a desired turn rate of the legged robot, (iv) a desired stair height for climbing stairs, (v) a desired energy consumption of the legged robot, (vi) a desired foot slippage of the legged robot, and (vii) a desired ground reaction force of the legs of the legged robot. The satisfaction of the performance objective 730 is observed by tracking the state of the reference trajectory being followed by legged robot 110.

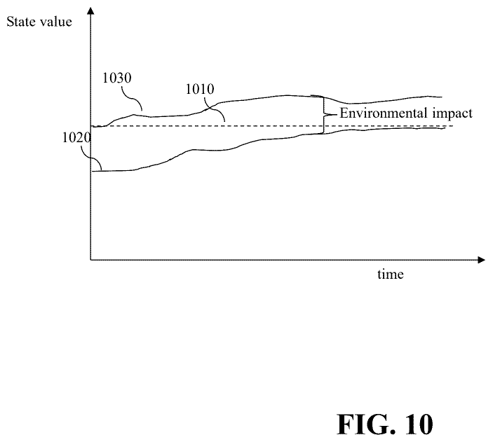

FIG. 10 illustrates tracking the state of the reference trajectory, according to some embodiments of the present disclosure. In one example, the legged robot 110 may be required to walk at a certain desired walking speed 1010 given by the performance objective 730. However, due to the impact of the environment or noise, there may be a difference between the actual achieved walking speed 1020 by the legged robot 110 and the state 1030 in the reference trajectory generator 160 representing the walking speed. In this example, the tracking of the performance objective 730 enables the legged robot 110 to walk at the desired walking speed 1010 by adjusting the state 1030 in the reference trajectory generator 160. In this scenario, the state 1030 of the reference trajectory generator 160 is a means to achieve the desired walking speed 1010 of the legged robot 110. Hence, the state of the reference trajectory generator 160 tracks certain requirements provided by the performance objective 730.

Some embodiments use a parametrization of the reference trajectory for the legged robot's CoM and the reference trajectories for the legs,

$$\{ {z}_{k , ref} , {z}_{k + 1 , ref} , … , {z}_{k + N , ref} \} = refTrajGen ( {z}_{k} , {θ}_{k} ) , \qquad ( 6 )$$

where refTrajGen(zₖ, θₖ) is a function that takes the current state of the legged robot 110 zₖ and parameters θₖ. For example, the parameters θₖ may include a walking speed of the legged robot 110, a foot clearance of the legs of the legged robot 110, the legged robot's rotation, and the like.

The reference trajectory may then be computed using the parameters and a set of basis function. For example, there may be the same number of parameters as there are basis functions and the reference trajectory may be computed by multiplying the parameters with the basis functions,

$$\{ {z}_{k , ref} , {z}_{k + 1 , ref ,} {z}_{k + N , ref} \} = {\sum }_{i = 1}^{{N}_{BF}} {θ}_{i} {ϕ}_{i} ( {z}_{k} ) , \qquad ( 7 )$$

where φᵢ with i=1, . . . N_{BF} are the basis functions. Alternatively, there may be more basis functions than there are parameters, and the parameters may be shared among one or multiple basis functions.

For example, reference trajectories may consist of a reference trajectory for the center of mass of the robot's base and four reference trajectories for the four feet of the robot. The reference trajectory for the center of mass of the robot's base may be computed with a linear interpolation using the current body position

$${r}_{k - N}^{ref} ∈ {\text{?}}^{3} ,$$

the current body orientation

$${Θ}_{k - N}^{ref} ∈ {\text{?}}^{3} ,$$

and a desired next body position

$${r}_{k}^{ref} ∈ {\text{?}}^{3}$$

and a desired next body orientation

$${Θ}_{k}^{ref} ∈ {\text{?}}^{3} ,$$

$$[ \begin{matrix}{r}_{t}^{ref} \\ {Θ}_{t}^{ref}\end{matrix} ] = \frac{N - k + t}{N} [ \begin{matrix}{r}_{k}^{ref} \\ {Θ}_{k}^{ref}\end{matrix} ] + ( 1 - \frac{N - k + t}{N} ) [ \begin{matrix}{r}_{k - N}^{ref} \\ {Θ}_{k - N}^{ref}\end{matrix} ] \qquad ( 8 )$$

with t=k−N, k−N+1, . . . , k, which may be computed using a desired velocity of the robot's base

$${v}_{k - N}^{ref} ∈ {\text{?}}^{3}$$

and a desired angular velocity of the robot's base

$${ω}_{k - N}^{ref} ∈ {\text{?}}^{3}$$

over a certain phase duration ΔT

$$[ \begin{matrix}{r}_{k}^{ref} \\ {Θ}_{k}^{ref}\end{matrix} ] = [ \begin{matrix}{r}_{k - N}^{ref} \\ {Θ}_{k - N}^{ref}\end{matrix} ] + [ \begin{matrix}{v}_{k - N}^{ref} \\ {ω}_{k - N}^{ref}\end{matrix} ] Δ T . \qquad ( 9 )$$

An advantage of this reference trajectory computation is that it can be easily parametrized, e.g., using the desired angular velocity. The four reference trajectories for the four feet of the robot may be computed using four current foot positions

$${p}_{i , k - N}^{ref} ∈ {\text{?}}^{3}$$

with i=1,2,3,4 and four desired foot velocities

$${v}_{i , k - N}^{ref} ∈ {\text{?}}^{3}$$

in order to compute four desired next foot positions

$${p}_{i , k}^{ref} ∈ {\text{?}}^{3} ,$$

$${p}_{i , k}^{ref} = {p}_{i , k - N}^{ref} + {v}_{i , k - N}^{ref} Δ T . \qquad ( 10 )$$

The four desired foot velocities

$${v}_{i , k - N}^{ref}$$

may be given by the desired velocity of the robot's base

$${v}_{k - N}^{ref} .$$

The four reference trajectories for the four feet of the robot may result from a set of basis function such as a cycloidal swing motion, an ellipsoidal swing motion, a triangular swing motion, or the like. For example, for the cycloidal swing motion, the four reference trajectories for the four feet of the robot may be computed by fitting a cycloid with a certain apex height

$${p}_{max}^{z} ∈ \text{?}$$

to the four current foot positions

$${p}_{i , k - N}^{ref}$$

and the four desired next foot positions

$${p}_{i , t}^{x , ref} = {p}_{i , k - N}^{x , ref} + ( {p}_{i , k}^{x , ref} - {p}_{i , k - N}^{x , ref} ) \frac{s ( t ) - sin ( s ( t ) )}{2 π} \qquad ( 11 )$$

$${p}_{i , t}^{y , ref} = {p}_{i , k - N}^{y , ref} + ( {p}_{i , k}^{y , ref} - {p}_{i , k - N}^{y , ref} ) \frac{s ( t ) - sin ( s ( t ) )}{2 π}$$

$${p}_{i , t}^{z , ref} = \{ \begin{matrix}{p}_{i , k - N}^{z , ref} + {p}_{max}^{z , ref} \frac{1 - cos ( s ( t ) )}{2} & if s ( t ) \leq π \\ {p}_{i , k}^{z , ref} + ( {p}_{max}^{z , ref} + {p}_{i , k - N}^{z , ref} - {p}_{i , k}^{z , ref} ) \frac{1 - cos ( s ( t ) )}{2} & else\end{matrix}$$

with

$$s ( t ) = 2 π \frac{N - k + t}{N}$$

and t=k−N, k−N+1, . . . , k and i=1,2,3,4.

Some embodiments are based on parametrizing the reference trajectory calculation. For example, the parameters may include the apex height

$${p}_{max}^{z}$$

and the desired velocity of the robot's base

$${v}_{k - N}^{ref} .$$

However, changing the apex height

$${p}_{max}^{z}$$

and the desired velocity of the robot's base

$${v}_{k - N}^{ref}$$

may also impact other requirements of the robot's motion such as energy consumption or foot slippage. Indeed, if the apex height

$${p}_{max}^{z}$$

is increased, the energy consumption of the electric motors may increase as the electric motors may need to exert more torque. Furthermore, if the desired velocity of the robot's base

$${v}_{k - N}^{ref}$$

is increased, the foot slippage may occur because the robot's feet may push forward too aggressively.

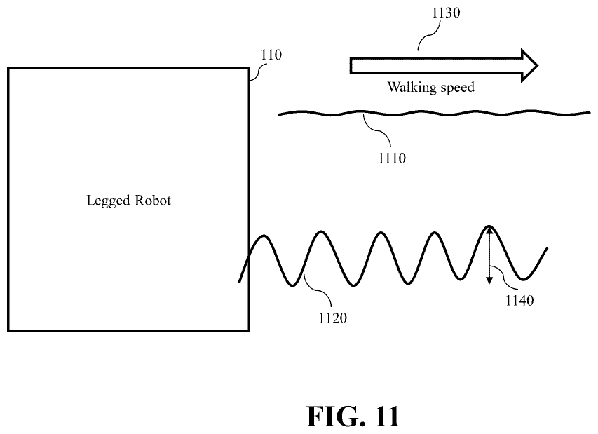

FIG. 11 illustrates parametrization of reference trajectories for a legged robot, according to some embodiments of the present disclosure. The parametrization of the reference trajectory includes parameterizing the legged robot's CoM and the reference trajectories for the legs. In this illustrative example, the reference trajectory for the legged robot's CoM 1110 and the reference trajectories for the legs 1120 may be parametrized using a walking speed 1130 of the legged robot 110 and/or a foot clearance 1140 of the legged robot 110.

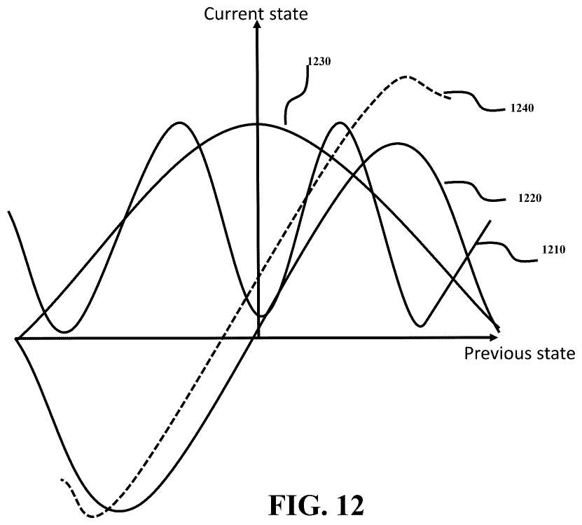

FIG. 12 illustrates an example of the use of weighted basis function to define a parameter according to an embodiment. In the illustration there are three basis functions: a basis function 1210, a basis function 1220, and a basis function 1230. Also shown is a true function of a parameter 1240 that together with a motion model maps a previous state to a current state. By combining the basis functions and using different weights for each basis functions, they can be combined to reproduce the true function of the parameter, hence the true motion model.

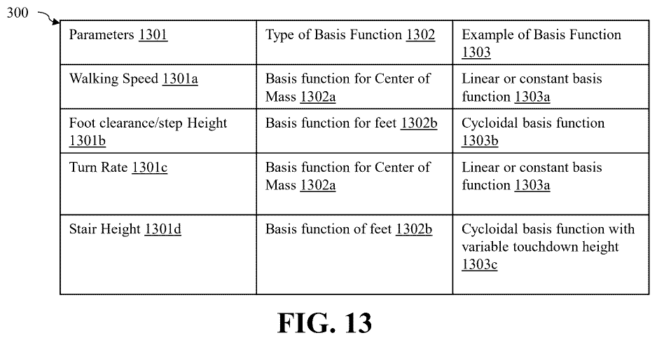

FIG. 13 illustrates a table 1300 representing the encoding/decoding of parameters 1301 associated with a reference trajectory related to a task using basis function. The table illustrates type of basis function 1302 and an example of the basis function 1303 for each parameter. Examples of few parameters include walking speed 1301a, foot clearance/step height 1301b, turn rate 1301c, stair height 1301d, etc. The task may include basis functions for the center of mass 1302a and basis functions for the feet 1302b. For example, for the walking speed 1301a, the reference trajectory for the center of mass may be computed by using the basis function for the center of mass 1302a, which may be linear or constant basis function 1303a or a combination thereof. For example, a reference position for the center of mass can be computed by extrapolating the walking speed 1301a parameter in combination with a linear basis function,

$${p}_{k + t}^{ref , CoM} = {p}_{k}^{CoM} + {θ}_{walking} t \qquad ( 12 )$$

The task may be to achieve a certain foot clearance 1301b. For example, the task may use basis functions for the feet 1302b, which may be given by cycloidal basis function 1303b. In this example, the reference trajectory for the feet is given by an initial position of the foot, a touchdown position for the foot, and the cycloidal basis function connecting the initial position and the touchdown position thereby achieving the foot clearance. Thus, a cycloidal basis function with variable touchdown height 1303c may be used. Alternatively, the task may be to climb a stair. In this example, the touchdown position of the foot may be changed to account for the height of the stairs.

The parameters and basis functions illustrated in the table 1300 are for example purpose only and need not be construed to be limiting the scope of this disclosure in any way.

### EXEMPLAR EMBODIMENTS

The following description provides exemplary embodiments and implementations to illustrate various aspects of the claimed subject matter and enable those skilled in the art to practice the disclosed technology. These embodiments are provided by way of example and not by way of limitation. The specific configurations, functionalities, and implementations described herein are intended to facilitate an understanding of the disclosure and should not be construed as limiting the scope of the claims. Variations, modifications, and alternative embodiments may be employed without departing from the spirit and scope of the claimed disclosure, as will be understood by those skilled in the art. The scope of the disclosure is defined solely by the claims, and any embodiments described herein should be regarded as illustrative rather than restrictive.

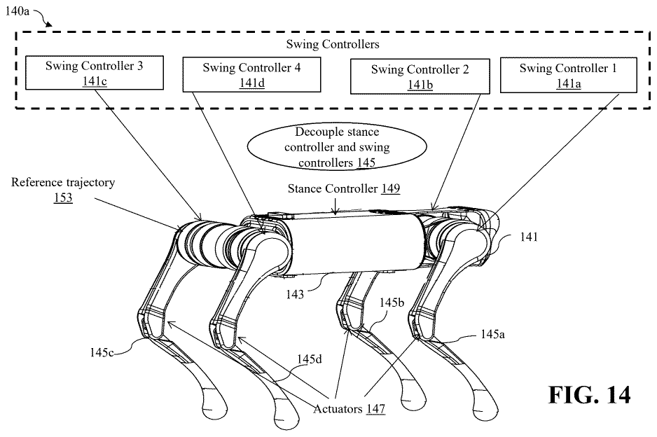

FIG. 14 illustrates a schematic configuration 140a of a multi-legged robot 141, designed to navigate dynamic and uncertain environments using an advanced probabilistic control system, in accordance with some embodiments. The multi-legged robot 141 includes a trunk 143, a plurality of legs, including leg 145a, leg 145b, leg 145c, and leg 145d, and one or more actuators 147 responsible for leg articulation and movement. The legs support the trunk 143 above the ground, ensuring stability and adaptability in varied terrains.

For ease of explanation, the multi-legged robot 141 is shown with four legs, forming a quadrupedal robotic system. However, alternative embodiments may include two or more legs, allowing for different morphologies such as bipedal or hexapod configurations. The one or more actuators 147 are depicted separately but may be integrated within the multi-legged robot 141 to optimize performance and efficiency.

To facilitate robust locomotion, the robot operates under the control of a stance controller 149, which is associated with the trunk 143, and a plurality of swing controllers 141a, 141b, 141c, 141d, each governing the movement of a respective leg. Specifically:

Swing Controller 1, 141a, is associated with Leg 145a; Swing Controller 2, 141b, is associated with Leg 145b; Swing Controller 3, 141c, is associated with Leg 145c; and Swing Controller 4, 141d, is associated with Leg 145d.

This multi-controller structure allows for real-time adjustments in response to external forces and terrain variations. The stance controller 149 governs the overall body posture and weight distribution, while each swing controller 141a-c independently regulates the movement of its corresponding leg.

In various embodiments, the multi-legged robot 141 is engineered for diverse operational tasks, such as: search and rescue operations in hazardous environments, warehouse logistics and material transport, infrastructure inspection for maintenance and safety assessment, security patrols in dynamic settings, and environmental monitoring for data collection and exploration.

The robot follows a reference trajectory 153, which defines its planned motion. This trajectory encompasses one or a combination of path and sequence of states over time and space, 3D Cartesian coordinates for navigation, joint angles and step heights for leg articulation, velocity and acceleration profiles for smooth transitions, orientation adjustments for balance and maneuverability, contact force estimation for detecting and responding to ground interactions. Unlike pre-computed trajectories that may not accommodate real-time disturbances, this system dynamically updates the reference trajectory 153 based on probabilistic force estimation.

In some implementations, the control of the multi-legged robot 141 is configured to synchronize the trunk motion (stance phase) with the leg motion (swing phase) for smooth and stable locomotion. However, computing the full-body motion trajectory in real-time is computationally expensive. To address this, in some implementations, the system decouples 145 the stance controller 149 from the swing controllers 141a, 141b, 141c, 141d, enabling independent computation of trunk motion (stance phase), and independent computation of individual leg motion (swing phase). This decoupled structure enhances modular control while maintaining real-time responsiveness, improving the robot's ability to traverse challenging terrains without requiring excessive computational resources.

Some embodiments integrate the control strategy of the multi-legged robot 141 with probabilistic force estimation and adaptive control, leveraging an advanced Interacting Multiple-Model (IMM) Kalman Filter-based force estimation framework. This approach enables the robot to infer pseudo-measurements of external forces from joint encoders and dynamic models, facilitating real-time tracking of external force interactions and distinguishing between swing, stance, and collision modes. By incorporating adaptive motion control, the system utilizes Reflex Motion Control for immediate collision response and Admittance Motion Control for force-adaptive compliance. These probabilistic methods enhance the robot's ability to react swiftly to unexpected contact events while maintaining stability, significantly improving its capability to operate autonomously in unstructured environments.

In effect, the multi-legged robot 141, depicted in FIG. 14, embodies an adaptive locomotion system. Through a decoupled control architecture, probabilistic force estimation, and dynamic reference trajectory adaptation, the robot achieves enhanced agility, robustness, and efficiency in navigating complex terrains. This architecture is particularly beneficial in applications where real-time adaptability to external disturbances is crucial for safe and efficient operation.

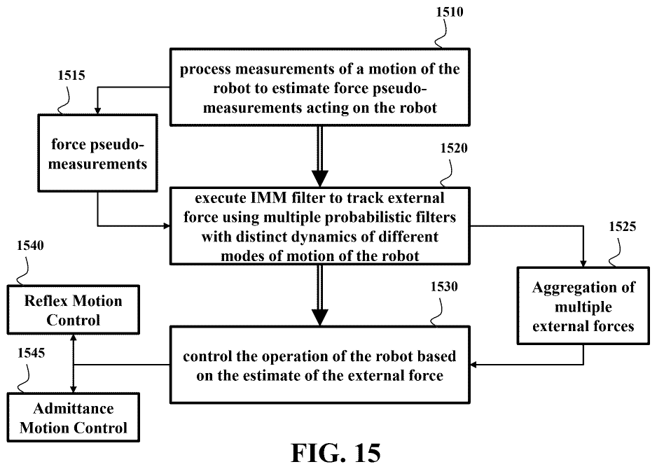

FIG. 15 shows a schematic of a probabilistic feedback controller for robot control using an interacting multiple-model (IMM) framework, in accordance with some embodiments. The disclosed probabilistic feedback controller provides an advanced mechanism for controlling robotic motion by estimating external forces acting on the robot using an Interacting Multiple-Model (IMM) framework. This controller, implemented via at least one processor executing instructions stored in memory, dynamically adjusts robot behavior based on estimated external forces. The system is particularly advantageous in robotic applications such as legged locomotion, where reliable force estimation and adaptive motion control are critical for navigating uncertain and dynamic environments.

The controller first processes 1510 digital representations of the robot's motion measurements. These measurements are leveraged to estimate force pseudo-measurements 1515, i.e., representations of external forces, based on available sensor data, such as joint encoder readings and dynamic models of the robot. Unlike approaches relying on force sensors, the use of pseudo-measurements enables a cost-effective and robust means of estimating external contact forces.

To improve the accuracy of force estimation, the controller employs 1520 an Interacting Multiple-Model (IMM) filter composed of multiple probabilistic filters (e.g., Kalman filters). Each filter corresponds to a distinct mode of the robot's motion, such as swing, stance, and collision. The IMM filter continuously tracks the external forces acting on the robot by combining mode-specific force estimates. Each probabilistic filter models the dynamics associated with a specific mode of motion, and the IMM framework assigns probabilities to these modes, dynamically adapting to transitions between them. By aggregating force estimates from different filters according to their probabilities, the IMM filter generates 1525 a refined estimation of the external force.

The estimated external force is then utilized to adaptively control 1530 the robot's operation using one or both of the following control strategies, such as reflex motion control 1540 and admittance motion control 1545. During the Reflex Motion Control 1540, when a collision or unexpected contact is detected, the controller triggers an immediate corrective action by adjusting the robot's movement. This response minimizes potential disturbances and enhances the robot's ability to recover from unexpected interactions with the environment. During the Admittance Motion Control 1545, the controller modulates the robot's motion dynamics by adjusting position, velocity, or acceleration in response to external forces. This ensures compliant interaction with the environment, allowing for smooth navigation over uneven terrains or while encountering obstacles.

As a result, unlike the systems that rely on external sensors (such as force sensors or cameras), this approach enables robust force estimation purely from internal sensor data, making it more reliable in unstructured environments. The use of an IMM filter provides a computationally efficient mechanism for transitioning between different movement modes (e.g., normal gait, collision, stance) without requiring predefined heuristics or fixed thresholds. The combination of force estimation with reflex and admittance control enables the robot to react dynamically to external disturbances while maintaining balance and forward momentum.

The probabilistic filtering approach, particularly when executed via embedded processors, ensures real-time performance without excessive computational overhead. This probabilistic feedback controller enhances the adaptability and robustness of robotic motion control, particularly in dynamic environments where external forces and contact conditions are uncertain or rapidly changing.

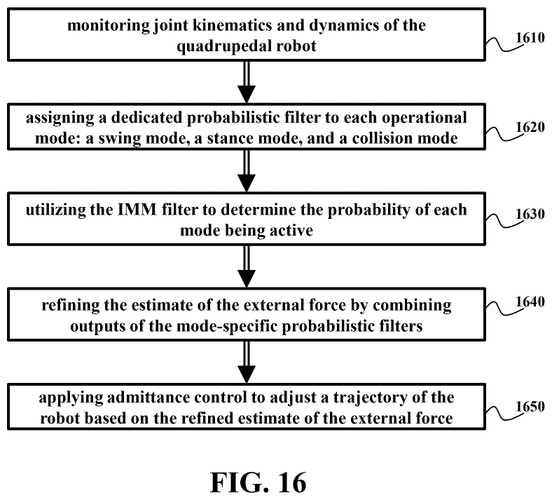

FIG. 16 illustrates the control architecture of a quadrupedal robot leveraging probabilistic force estimation and adaptive control to enhance locomotion stability and responsiveness in dynamic environments, in accordance with some embodiments. The controller enables the quadrupedal robot to operate in distinct gait-dependent modes, adapting to external forces and environmental disturbances.

To achieve robust force estimation and control, the controller is configured to monitor 1610 joint kinematics and dynamics to compute pseudo-measurements of external forces, using internal sensor data rather than external force sensors. The controller assigns 1620 a dedicated probabilistic filter to each operational mode, including swing mode, stance mode, and collision mode, where each mode exhibits unique dynamic properties influencing force interactions, and utilize 1630 the IMM filter employing mode-dependent probabilistic filters 1620 to determine the probability of each mode being active based on the robot's movement and the computed pseudo-measurements, allowing for real-time adaptation to terrain changes.

The controller refines 1640 the external force estimation by aggregating outputs from multiple mode-specific probabilistic filters, enhancing accuracy and reliability in force perception, and applies 1640 admittance control to dynamically adjust the robot's trajectory based on the refined force estimates, ensuring compliant motion and effective disturbance rejection.

In some embodiments, the probabilistic filtering framework integrates force pseudo-measurements with Kalman filters assigned to each motion mode, allowing for real-time state estimation and adaptive control. Each Kalman filter is configured to track estimates of the external forces, utilizing a process model subject to process noise, and a measurement model subject to measurement noise. The process model of each probabilistic filter corresponds to either a swing mode or a contact mode for predicting the external forces. In contrast, the measurement model corresponds to one of a swing mode, a stance mode, or a collision mode to adapt the predictions of the process model based on the force pseudo-measurements. By continuously refining force estimations and adjusting motion trajectories accordingly, the quadrupedal robot achieves improved balance, stability, and adaptability in challenging and unstructured environments.

FIG. 16 illustrates the control architecture of a quadrupedal robot leveraging probabilistic force estimation and adaptive control to enhance locomotion stability and responsiveness in dynamic environments, in accordance with some embodiments. The controller enables the quadrupedal robot to operate in distinct gait-dependent modes, dynamically adapting to external forces and environmental disturbances while ensuring smooth and stable movement across varying terrains. The Interacting Multiple-Model Kalman Filter (IMM-KF) framework is employed to estimate external forces and classify contact modes based on proprioceptive sensing, thereby improving motion adaptation and disturbance rejection.

To achieve robust external force estimation and contact mode identification, the controller monitors 1610 joint kinematics and dynamics to compute pseudo-measurements of external forces, relying exclusively on internal sensor data rather than external force sensors. This estimation is achieved using the generalized momentum (GM) dynamics,

$$p = M ( q ) \dot{q} ;$$

which provides an analytical foundation for force tracking.

Differentiating the generalized momentum with respect to time yields:

$$\dot{p} = M ( q ) \ddot{q} + C ( q , \dot{q} ) + g ( q ) ;$$

which, when considering joint torques and external disturbances, extends to:

$$\dot{p} = {τ}_{m} - {τ}_{f} + {C}^{T} \dot{q} - g + {τ}_{ext} ;$$

where: τₘ is the motor-induced torque, τ_{f} represents joint frictional torques, C^{T}\dot{q} accounts for Coriolis and centrifugal effects, g denotes gravitational effects, and τₑₓₜ corresponds to the external joint torques due to ground reaction forces.

The external force estimation is derived from the joint torque equation:

$${τ}_{ext} = {\sum }_{j = 1}^{{n}_{f}} {J}_{cj}^{T} ( q ) {F}_{ext , j} ;$$

where: J_{cj}(q) is the geometric contact Jacobian, and F_{ext,j} represents the external forces acting on the foot.

The controller assigns 1620 a dedicated probabilistic filter to each operational mode, distinguishing among swing mode, stance mode, and collision mode. Each mode-dependent process model is defined as:

$$[ \begin{matrix}\dot{p} \\ {\dot{f}}_{ext}\end{matrix} ] = [ \begin{matrix}0 & S ( k ) {J}^{T} \\ 0 & A\end{matrix} ] [ \begin{matrix}p \\ {f}_{ext}\end{matrix} ] + [ \begin{matrix}I \\ 0\end{matrix} ] u + [ \begin{matrix}{ω}_{p} \\ {ω}_{f}\end{matrix} ] ;$$

where: S(k) is the selection matrix, differentiating between swing mode (k=1) and contact modes (k=2, 3), A_{f} is a damping matrix, stabilizing force estimation, u represents control inputs, and ωₚ, ω_{f} denote process noise terms.

The IMM filter, utilized in 1630, combines multiple mode-specific probabilistic filters to determine the probability of each mode being active based on the robot's movement and computed pseudo-measurements. The IMM framework implements Bayesian estimation with a Markovian switching model:

$$Pr ( {m}_{t + 1} = m ( j ) \vert {m}_{t} = m ( i ) ) = {π}_{ij} ;$$

where: mₜ represents the current mode at time t, and πᵢⱼ defines the transition probability matrix.

The controller refines 1640 the external force estimation by aggregating outputs from multiple mode-specific probabilistic filters, enhancing accuracy and reliability in force perception. This refined estimation feeds into an admittance control strategy, dynamically adjusting the robot's trajectory based on external force interactions.

The external force acting on the robot, fₑₓₜ, is estimated using an Interacting Multiple-Model Kalman Filter (IMM-KF). This method incorporates multiple probabilistic filters, each corresponding to a specific contact mode (k) such as swing mode, stance mode, or collision mode.

Each Kalman filter updates its force estimate according to the mode-dependent process model:

$${x}_{t + 1}^{( k )} = {A}^{( k )} {x}_{t}^{( k )} + {B}^{( k )} {u}_{t} + {w}_{t}^{( k )} ;$$

where:

$${x}_{t}^{( k )}$$

represents the state estimate (including external forces and generalized momentum), A^{(k)} is the mode-dependent state transition matrix, B^{(k)} maps control inputs to states, uₜ is the control input (joint torques),

$${w}_{t}^{( k )}$$

represents process noise.

Each filter produces a mode-specific estimate of the external force:

$${\hat{f}}_{ext}^{( k )} = {C}^{( k )} {x}_{t}^{( k )} + {v}_{t}^{( k )} ;$$

where: C^{(k)} is the measurement model matrix,

$${v}_{t}^{( k )}$$

is measurement noise.

In some embodiments, the IMM-KF computes the final force estimate as a probability-weighted sum of all mode-specific estimates:

$${\hat{f}}_{ext} = {\sum }_{k = 1}^{M} {μ}_{t}^{( k )} {\hat{f}}_{ext}^{( k )} ;$$

where:

$${μ}_{t}^{( k )}$$

is the probability of mode k being active, computed using Bayesian updates, as described above. This probabilistic combination ensures accurate force estimation, even when the robot rapidly transitions between gait phases.

The admittance control law modifies 1650 the foot position response as:

$$\ddot{r} = {M}^{- 1} ( {f}_{ext} - D ( \dot{r} - {\dot{r}}_{d} ) - K ( r - {r}_{d} ) ) + {\ddot{r}}_{d} ;$$

where: r, r_{d} are the current and desired foot positions, fₑₓₜ is the estimated external force, M, D, K are the virtual mass, damping, and stiffness coefficients, regulating compliance.

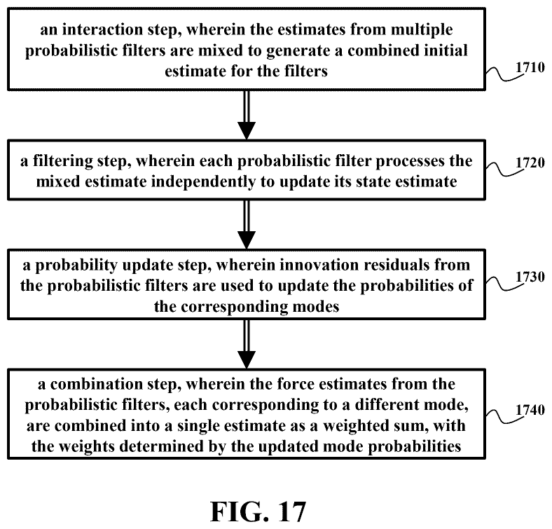

FIG. 17 shows a block diagram of the probabilistic force estimation framework using an Interacting Multiple-Model Kalman Filter (IMM-KF) for a quadrupedal robot, enabling simultaneous contact mode estimation and external force tracking. This architecture improves the robot's ability to react to external disturbances by dynamically identifying the active contact mode and refining force estimates in real time. The process includes four key steps: interaction 1710, filtering 1720, probability update 1730, and combination 1740, which collectively enhance the estimation of contact forces and mode transitions.

The first step in the IMM-KF framework is the interaction step (1710), where estimates from multiple probabilistic filters are mixed to generate a combined initial estimate for each filter. This step ensures that state estimates are propagated across multiple mode hypotheses, improving robustness to uncertain mode transitions.

In some implementations, the mode-conditioned estimates

$${x}_{t}^{( j )}$$

and their covariances

$${P}_{t}^{( j )}$$

are blended based on prior mode probabilities:

$${\overline{x}}_{t}^{( k )} = {\sum }_{j = 1}^{M} {μ}_{t - 1}^{( j \vert k )} {x}_{t}^{( j )} ;$$

$${P}_{t}^{( k )} = {\sum }_{j = 1}^{M} {μ}_{t - 1}^{( j \vert k )} ( {P}_{t}^{( j )} + ( {x}_{t}^{( j )} - {\overline{x}}_{t}^{( k )} ) {( {x}_{t}^{( j )} - {\overline{x}}_{t}^{( k )} )}^{T} ) ;$$

where:

$${μ}_{t - 1}^{( j \vert k )}$$

is the probability of transitioning from mode j to k,

$${\overline{x}}_{t}^{( k )}$$

is the mixed state estimate used to initialize each filter, and

$${P}_{t}^{( k )}$$

is the mixed covariance.

This interaction step ensures that even if the true mode is unknown, each filter starts with a reasonable estimate, preventing sudden discontinuities when modes switch.

In the filtering step (1720), each probabilistic filter processes the mixed estimate independently to update its state estimate based on mode-specific dynamics. Each Kalman filter runs a standard prediction-update cycle, where the process model governs state evolution, and the measurement model refines predictions using observed data.

The prediction step follows the mode-conditioned linear system

$${x}_{t + 1}^{( k )} = {A}_{t}^{( k )} {x}_{t}^{( k )} + {B}_{t}^{( k )} {u}_{t} + {w}_{t}^{( k )} ;$$

$${P}_{t + 1}^{( k )} = {A}_{t}^{( k )} {P}_{t}^{( k )} {A}_{t}^{( k ) T} + {Q}_{t}^{( k )} ;$$

where

$${A}_{t}^{( k )}$$

represents the mode-dependent state transition matrix,

$${B}_{t}^{( k )}$$

maps control inputs to states, uₜ is the control input (e.g., joint torques), and

$${w}_{t}^{( k )}$$

is the process noise covariance.

During the update step, measurements refine the estimates using:

$$a . {\tilde{y}}_{t}^{( k )} = {y}_{t} - {C}_{t}^{( k )} {x}_{t}^{( k )} ; \\ b . {S}_{t}^{( k )} = {C}_{t}^{( k )} {P}_{t}^{( k )} {C}_{t}^{( k ) T} + {R}_{t}^{( k )} ; \\ c . {K}_{t}^{( k )} = {P}_{t}^{( k )} {C}_{t}^{( k ) T} {S}_{t}^{{( k ) - 1}^{}} ; \\ d . {x}_{t}^{( k )} = {x}_{t}^{( k )} + {K}_{t}^{( k )} {\tilde{y}}_{t}^{( k )} ; and \\ e . {P}_{t}^{( k )} = ( I - {K}_{t}^{( k )} {C}_{t}^{( k )} ) {P}_{t}^{( k )} ;$$

where:

$${C}_{t}^{( k )}$$

is the measurement model matrix, yₜ is the measured state (e.g., force pseudo-measurements),

$${K}_{t}^{( k )}$$

is the Kalman gain optimizing measurement weighting.

In the probability update step (1730), the system evaluates the likelihood of each mode using the innovation residual and updates the probability of mode k being active at time t:

$${L}_{t}^{( k )} = \frac{exp ( - \frac{1}{2} {( {\tilde{y}}_{t}^{( k )} )}^{T} {S}_{t}^{( k ) - 1} {\tilde{y}}_{t}^{( k )} )}{\sqrt{\vert 2 π {S}_{t}^{( k )} \vert}} ; \\ {μ}_{t}^{( k )} = \frac{{c}^{( k )} {L}_{t}^{( k )}}{{\sum }_{i = 1}^{M} {c}^{( i )} {L}_{t}^{( i )}} ;$$

where:

$${L}_{t}^{( k )}$$

is the likelihood of mode k,

$${μ}_{t}^{( k )}$$

is the updated probability of mode k being active, and c^{(k)} is a normalization constant.

In the final combination step (1740), force estimates from multiple probabilistic filters are combined into a single estimate using the updated mode probabilities:

$${x}_{t} = {\sum }_{k = 1}^{M} {μ}_{t}^{( k )} {x}_{t}^{( k )} ; and \\ {P}_{t} = {\sum }_{k = 1}^{M} {μ}_{t}^{( k )} ( {P}_{t}^{( k )} + ( {x}_{t} - {x}_{t}^{( k )} ) {( {x}_{t} - {x}_{t}^{( k )} )}^{T} ) .$$

This ensures that the external force estimate smoothly adapts as contact modes shift, allowing for real-time motion adjustment.

In effect, the IMM-KF framework in FIG. 17 enables a quadrupedal robot to dynamically transition between gait phases, distinguishing between swing, stance, and collision modes. By integrating probabilistic filtering, the system achieves robust force estimation, real-time mode classification, and adaptive locomotion control, significantly improving stability and resilience in challenging environments.

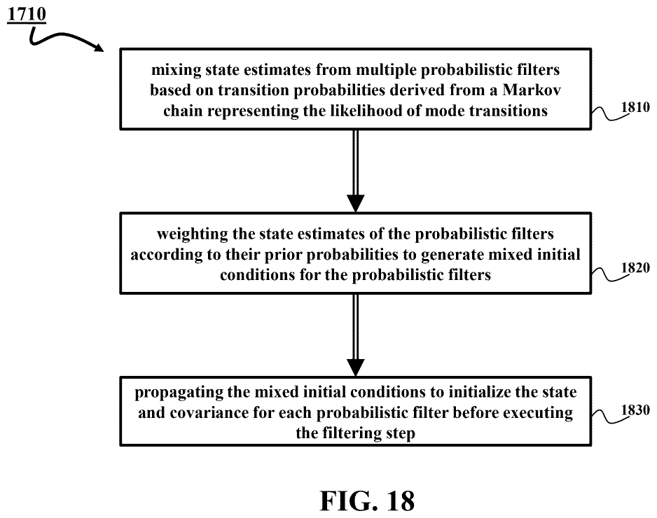

FIG. 18 illustrates a flowchart of a method for implementing the interaction step 1710, in accordance with some embodiments. The method comprises steps for processing multiple probabilistic filters within an Interacting Multiple-Model Kalman Filter (IMM-KF) framework, ensuring a smooth transition between different contact modes of a quadrupedal robot.

At step 1810, the method includes mixing state estimates from multiple probabilistic filters based on transition probabilities. The method computes a weighted combination of prior state estimates, where the weights correspond to transition probabilities derived from a Markov chain representing the likelihood of transitioning between different modes. The mixed state estimate for each mode k is computed as:

$${\overline{x}}_{t}^{( k )} = {\sum }_{j = 1}^{M} {μ}_{t - 1}^{( j \vert k )} {x}_{t}^{( j )} ;$$

where:

$${x}_{t}^{( j )}$$

is the state estimate from the probabilistic filter of mode j,

$${μ}_{t - 1}^{( j \vert k )}$$

represents the transition probability from mode j to mode k.

At step 1820, the method includes weighting the state estimates of the probabilistic filters according to their prior probabilities to generate mixed initial conditions for each probabilistic filter. The transition probabilities are obtained from a mode transition matrix governed by a first-order Markov process, where:

$$Pr ( {m}_{t + 1} = k \vert {m}_{t} = j ) = {π}_{jk} ;$$

where πⱼₖ represents the probability of transitioning from mode j to mode k, allowing the IMM-KF framework to probabilistically adapt to changing external force interactions.

At step 1830, the method includes propagating the mixed initial conditions to initialize the state estimate and covariance matrix for each probabilistic filter before executing the filtering step. The covariance matrix is computed as:

$${P}_{t}^{( k )} = {\sum }_{j = 1}^{M} {μ}_{t - 1}^{( j \vert k )} ( {P}_{t}^{( j )} + ( {x}_{t}^{( j )} - {\overline{x}}_{t}^{( k )} ) {( {x}_{t}^{( j )} - {\overline{x}}_{t}^{( k )} )}^{T} ) ;$$

where:

$${P}_{t}^{( j )}$$

is the covariance estimate for mode j. The computed mixed state estimate and covariance matrix are then used to initialize the mode-specific filters before the filtering step.

This method enables smooth mode transitions, ensuring that the probabilistic filters do not experience abrupt changes, thereby improving stability and accuracy in force estimation. The implementation of this method in the IMM-KF framework allows for robust real-time estimation of external forces and adaptive motion control in legged robotic systems.

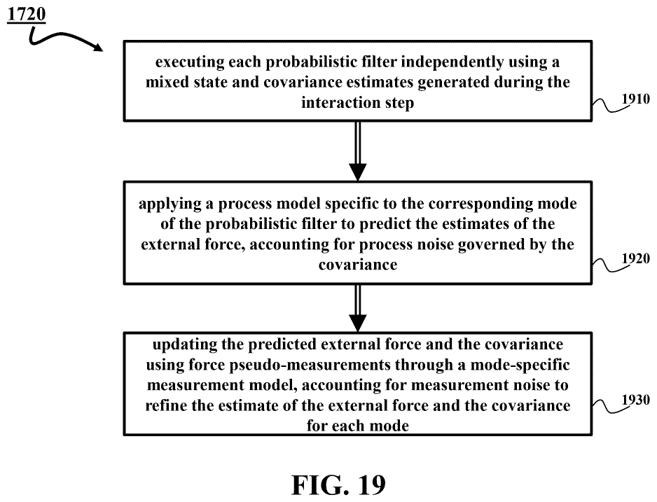

FIG. 19 illustrates a flowchart of a method for implementing the filtering step 1720 within the Interacting Multiple-Model Kalman Filter (IMM-KF) framework, in accordance with some embodiments. The filtering step processes mixed state estimates from the interaction step and applies mode-specific probabilistic filtering to track external forces acting on a quadrupedal robot. The method ensures that each probabilistic filter independently refines the force estimate for its respective contact mode, thereby improving robustness and accuracy in force estimation.

At step 1910, the method includes executing each probabilistic filter independently using the mixed state and covariance estimates generated during the interaction step 1710. Each probabilistic filter applies a mode-specific process model to propagate the external force estimates over time. The prediction step is governed by:

$${x}_{t + 1}^{( k )} = {A}_{t}^{( k )} {x}_{t}^{( k )} + {B}_{t}^{( k )} {u}_{t} + {w}_{t}^{( k )} ; and$$

$${P}_{t + 1}^{( k )} = {A}_{t}^{( k )} {P}_{t}^{( k )} {A}_{t}^{( k ) T} + {Q}_{t}^{( k )} ;$$

where:

$${A}_{t}^{( k )}$$

s the state transition matrix for mode k,

$${B}_{t}^{( k )}$$

maps control inputs uₜ to state variables,

$${w}_{t}^{( k )}$$

represents process noise,

$${P}_{t}^{( k )}$$

is the covariance matrix tracking the uncertainty in the state estimate.

The process model is mode-dependent and accounts for variations in force dynamics, whether the robot's leg is in swing mode, stance mode, or collision mode.

At step 1920, the method includes updating the predicted external force estimate using force pseudo-measurements, which are obtained from the quadrupedal robot's internal sensors. The update step refines the force estimate based on mode-specific measurement models, incorporating measurement noise into the Kalman filtering process:

$${\tilde{y}}_{t}^{( k )} = {y}_{t} - {C}_{t}^{( k )} {x}_{t}^{( k )} ;$$

$${S}_{t}^{( k )} = {C}_{t}^{( k )} {P}_{t}^{( k )} {C}_{t}^{( k ) T} + {R}_{t}^{( k )} ;$$

$${K}_{t}^{( k )} = {P}_{t}^{( k )} {C}_{t}^{( k ) T} {S}_{t}^{( k ) - 1} ;$$

$${x}_{t}^{( k )} = {x}_{t}^{( k )} + {K}_{t}^{( k )} {\tilde{y}}_{t}^{( k )} ;$$

$${P}_{t}^{( k )} = ( I - {K}_{t}^{( k )} {C}_{t}^{( k )} ) {P}_{t}^{( k )} ;$$

where:

$${C}_{t}^{( k )}$$

is the measurement model matrix for mode k, yₜ represents the measured pseudo-forces used to correct the state estimate,

$${K}_{t}^{( k )}$$

is the Kalman gain, which determines how much the measurement updates the predicted state, and

$${R}_{t}^{( k )}$$

is the measurement noise covariance.

At step 1930, the method includes refining the estimate of the external force by iteratively improving the state estimates using updated measurement information. The filtering step ensures that the external force estimation dynamically adapts to changing contact conditions, improving the quadrupedal robot's ability to handle force disturbances and maintain stable locomotion.

By executing each probabilistic filter independently, applying a process model specific to each mode, and updating force estimates using pseudo-measurements, the filtering step enhances the robot's perception of external forces. This method enables real-time adaptation to external disturbances, making it essential for adaptive locomotion and force-controlled movement in quadrupedal robots.

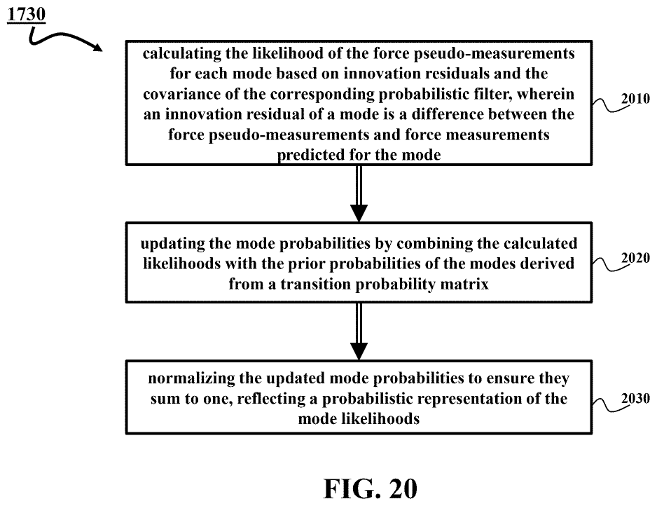

FIG. 20 illustrates a flowchart of a method for implementing the probability update step 1730 within the Interacting Multiple-Model Kalman Filter (IMM-KF) framework, in accordance with some embodiments. The probability update step refines the mode probabilities associated with different contact conditions of a quadrupedal robot by evaluating innovation residuals and updating the mode probabilities accordingly. This step ensures an accurate estimation of external forces by dynamically adjusting the weight assigned to each mode in the IMM-KF framework.

At step 2010, the method includes calculating the likelihood of the force pseudo-measurements for each mode based on the innovation residuals and the covariance of the corresponding probabilistic filter. The innovation residual for mode k is defined as the difference between the force pseudo-measurements and the predicted force measurements for that mode:

$${\tilde{y}}_{t}^{( k )} = {y}_{t} - {C}_{t}^{( k )} {x}_{t}^{( k )} ;$$

where: yₜ represents the observed pseudo-measurements,

$${C}_{t}^{( k )}$$

is the measurement model matrix for mode k,

$${x}_{t}^{( k )}$$

is the predicted state estimate.

The likelihood function

$${L}_{t}^{( k )}$$

for each mode is computed as:

$${L}_{t}^{( k )} = \frac{exp ( - \frac{1}{2} {( {\tilde{y}}_{t}^{( k )} )}^{T} {S}_{t}^{( k ) - 1} {\tilde{y}}_{t}^{( k )} )}{\sqrt{\vert 2 π {S}_{t}^{( k )} \vert}} ;$$

where:

$${S}_{t}^{( k )}$$

is the innovation covariance matrix, given by:

$${S}_{t}^{( k )} = {C}_{t}^{( k )} {P}_{t}^{( k )} {C}_{t}^{( k ) T} + {R}_{t}^{( k )} ;$$

where:

$${P}_{t}^{( k )}$$

is the state covariance estimate, and

$${R}_{t}^{( k )}$$

is the measurement noise covariance.

At step 2020, the method includes updating the mode probabilities by combining the calculated likelihoods with the prior probabilities of the modes derived from a transition probability matrix. The updated probability for mode k is computed as:

$${μ}_{t}^{( k )} = \frac{{c}^{( k )} {L}_{t}^{( k )}}{{\sum }_{i = 1}^{M} {c}^{( i )} {L}_{t}^{( i )}} ;$$

where: c^{(k)} is a normalization coefficient derived from prior mode probabilities, and

$${L}_{t}^{( k )}$$

is the likelihood function computed in step 2010.

At step 2030, the method includes normalizing the updated mode probabilities to ensure that the total probability sums to one, reflecting a probabilistic representation of the mode likelihoods:

$${\sum }_{k = 1}^{M} {μ}_{t}^{( k )} = 1.$$

This normalization step ensures that the estimated mode probabilities remain valid within the probabilistic framework.

By continuously updating mode probabilities based on observed force pseudo-measurements, the probability update step enhances the robustness of external force estimation. This step enables the IMM-KF framework to dynamically adapt to changing contact conditions, improving the accuracy and stability of the quadrupedal robot's motion control.

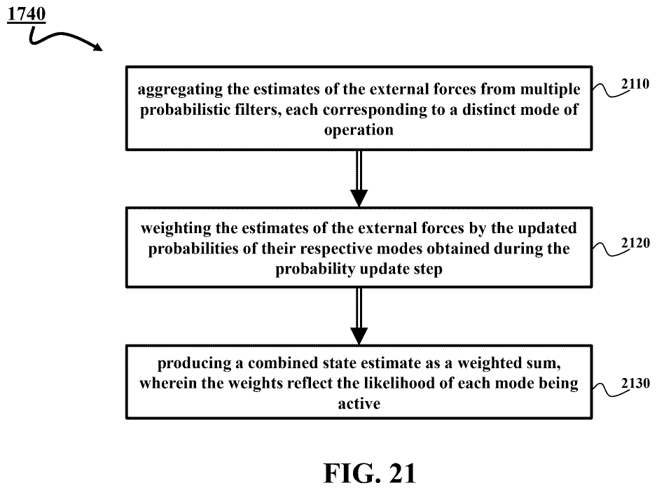

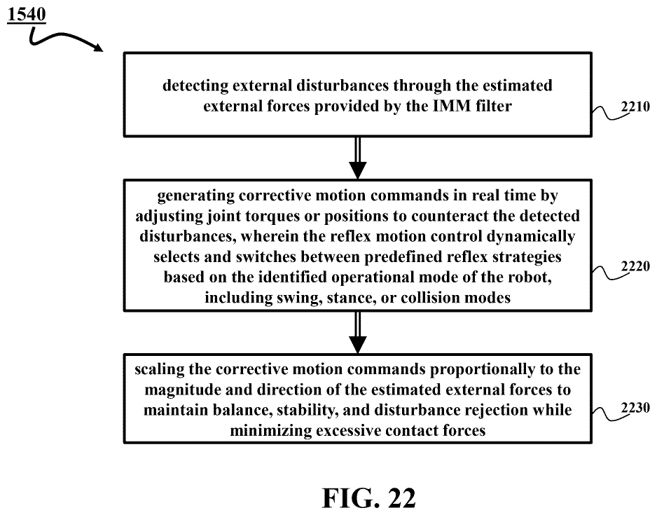

FIG. 21 illustrates a flowchart of a method for implementing the combination step 1740 within the Interacting Multiple-Model Kalman Filter (IMM-KF) framework, in accordance with some embodiments. The combination step aggregates external force estimates from multiple probabilistic filters, each corresponding to a distinct mode of operation, and produces a final combined force estimate. This step ensures that the estimated force reflects the most probable interaction mode while maintaining continuity in force estimation across mode transitions.

At step 2110, the method includes aggregating the estimates of the external forces from multiple probabilistic filters. Each probabilistic filter corresponds to a specific contact mode (e.g., swing mode, stance mode, and collision mode) and provides an independent estimate of the external force

$${\hat{f}}_{ext}^{( k )}$$

for that mode. The combination step ensures that the final estimate incorporates all mode-specific predictions to provide a more robust external force estimate.

At step 2120, the method includes weighting the estimates of the external forces by the updated probabilities of their respective modes obtained during the probability update step (1730). The final combined external force estimate is computed as a weighted sum:

$${\hat{f}}_{ext} = {\sum }_{k = 1}^{M} {μ}_{t}^{( k )} {\hat{f}}_{ext}^{( k )} ;$$

where:

$${μ}_{t}^{( k )}$$

is the updated probability of mode k being active, computed in step 1730,

$${\hat{f}}_{ext}^{( k )}$$

is the external force estimate from the probabilistic filter associated with mode k, and M represents the total number of modes.

At step 2130, the method includes producing a combined state estimate as a weighted sum, where the weights reflect the likelihood of each mode being active. The final state estimate is computed as:

$${x}_{t} = {\sum }_{k = 1}^{M} {μ}_{t}^{( k )} {x}_{t}^{( k )} ;$$

$${P}_{t} = {\sum }_{k = 1}^{M} {μ}_{t}^{( k )} ( {P}_{t}^{( k )} + ( {x}_{t} - {x}_{t}^{( k )} ) {( {x}_{t} - {x}_{t}^{( k )} )}^{T} ) ;$$

where:

$${x}_{t}^{( k )}$$

is the state estimate from mode k,

$${P}_{t}^{( k )}$$

is the covariance matrix for mode k, and Pₜ is the final covariance estimate, reflecting the uncertainty of the combined state estimate.

By continuously aggregating and weighting mode-specific force estimates, the combination step enables a smooth transition between different contact modes, reducing abrupt changes in force estimation. This step is valuable in real-time external force estimation, allowing the quadrupedal robot to adapt dynamically to contact variations and external disturbances.

FIG. 22 illustrates a flowchart of a method for implementing reflex motion control 1540 within a quadrupedal robot control system, in accordance with some embodiments. The reflex motion control system utilizes real-time force estimation provided by the Interacting Multiple-Model (IMM) Kalman Filter to dynamically respond to external disturbances by generating corrective motion commands that maintain stability and balance while mitigating excessive contact forces.

At step 2210, the method includes detecting external disturbances acting on the robot by analyzing the estimated external forces provided by the IMM filter. These force estimates are obtained from force pseudo-measurements derived from the robot's joint kinematics and dynamics, allowing the system to classify the nature and direction of external interactions affecting the robot's motion.

For example, these force estimates are derived from pseudo-measurements obtained using the robot's generalized momentum (GM) dynamics,

$$p = M \dot{q} ; \qquad a .$$

allowing the system to classify the nature and direction of external interactions.

By differentiating GM and incorporating external torques and motor torques, the estimated external force \hat{f}ₑₓₜ is obtained using:

$$\dot{p} = {τ}_{m} - {τ}_{f} + {C}^{T} \dot{q} - ℊ + {τ}_{ext} ;$$

$${\hat{f}}_{ext} = {( {JM}^{- 1} {J}^{T} )}^{†} ( {JM}^{- 1} {τ}_{m} + J \dot{q} ) ;$$

where: J is the geometric contact Jacobian, τₘ is the motor-induced joint torque, and τₑₓₜ is the external joint torque due to ground reaction forces.

At step 2220, the method includes generating corrective motion commands in real time to counteract the detected disturbances. The controller adjusts joint torques or positions to compensate for the external forces, thereby enhancing the robot's ability to recover from unexpected impacts. The corrective commands are dynamically selected from predefined reflex strategies, wherein the controller determines whether the robot is operating in a swing mode, stance mode, or collision mode and selects the appropriate response strategy based on the identified mode.

For example, in one implementation, the corrective torque is computed as:

$${τ}_{r} = {K}_{p} ( {θ}_{d} - θ ) + {K}_{d} ( {\dot{θ}}_{d} - \dot{θ} ) ;$$

where: τᵣ is the corrective torque, θ_{d} and \dot{θ}_{d} are the desired joint position and velocity, θ and \dot{θ} are the current joint position and velocity, and Kₚ and K_{d} are the proportional and derivative gains.

At step 2230, the method includes scaling the corrective motion commands proportionally to the magnitude and direction of the estimated external forces. The control system dynamically modulates the intensity of the corrective response to ensure optimal disturbance rejection while preventing excessive contact forces that may destabilize the robot. By continuously adjusting response intensity, the reflex motion control system ensures a balance between stability and compliance, allowing the robot to navigate dynamic environments while minimizing mechanical stress on its actuators.

For example, in one implementation, scaling the corrective motion commands proportionally to the magnitude and direction of the estimated external forces is determined according to

$${α}_{f} = min ( 1 , \frac{‖ {\hat{f}}_{e x t} ‖}{{f}_{max}} ) ;$$

$${τ}_{scaled} = {α}_{f} \cdot {τ}_{r} .$$

This ensures smooth reflex adaptation without excessive force application, enhancing stability.

By integrating real-time force estimation, mode-dependent reflex strategies, and adaptive corrective scaling, the reflex motion control system enhances the robot's ability to react to external disturbances while maintaining stability and efficiency in legged locomotion. As skilled artisan would readily recognize, the steps of the method for implementing the reflex motion control 1540 within a quadrupedal robot control system can be implemented in various manners. For example.

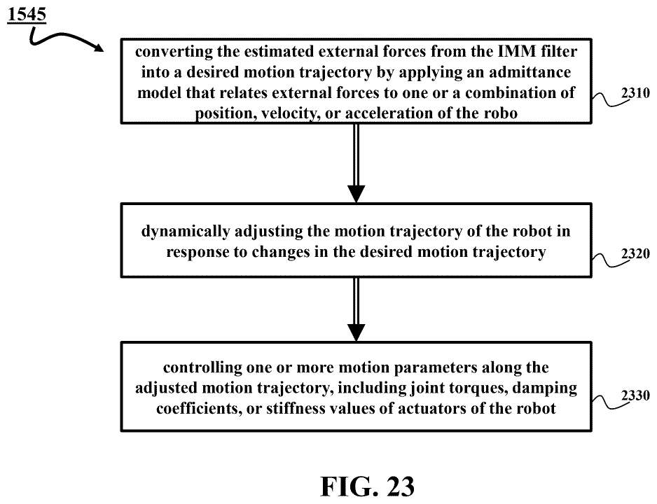

FIG. 23 illustrates a flowchart of a method for implementing the admittance motion control 1545 within a quadrupedal robot control system, in accordance with some embodiments. The admittance motion control system enables the robot to dynamically adjust its motion in response to external forces estimated by the Interacting Multiple-Model (IMM) Kalman Filter (KF) by modifying its position, velocity, or acceleration according to an admittance control model. This approach ensures compliant interactions with the environment while maintaining stability and motion precision.

At step 2310, the method includes converting the estimated external forces from the IMM-KF into a desired motion trajectory by applying an admittance model that relates the external forces to the motion states of the robot. The desired trajectory r_{d} is obtained using the second-order admittance equation, which governs the dynamic response of the system:

$$M {\ddot{r}}_{d} + D ( {\dot{r}}_{d} - {\dot{r}}_{0} ) + K ( {r}_{d} - {r}_{0} ) = {\hat{f}}_{e x t} ;$$

where: M, D, K are the virtual mass, damping, and stiffness matrices that define the system's compliance properties, r_{d} is the desired position, \dot{r}_{d} is the desired velocity, and \ddot{r}_{d} is the desired acceleration, r₀, \dot{r}₀ are the initial position and velocity, and \hat{f}ₑₓₜ is the estimated external force provided by the IMM-KF. This formulation ensures that the desired motion trajectory is dynamically adjusted based on external force interactions while maintaining smooth transitions and compliance.

At step 2320, the method includes adjusting the robot's motion trajectory in real time based on the computed desired trajectory r_{d}. The system continuously updates the reference motion by integrating the admittance equation, ensuring that the robot's trajectory remains adaptive to force variations. The updated motion states are computed as:

$${r}_{t} = {r}_{t - 1} + {\dot{r}}_{d} Δ t + \frac{1}{2} {{\ddot{r}}_{d} ( Δ t )}^{2} ;$$

$${\dot{r}}_{t} = {\dot{r}}_{t - 1} + {\ddot{r}}_{d} Δ t ;$$

where: Δt is the control update time step.

At step 2330, the method includes controlling parameters along the adjusted motion trajectory, such as joint torques, damping coefficients, and stiffness values, to regulate the robot's response to the estimated forces. The applied control law for adjusting torques is given by:

$$\begin{matrix}a . & τ = {J}^{T} M {\ddot{r}}_{d} + D ( {\dot{r}}_{d} - \dot{r} ) + K ( {r}_{d} - r )\end{matrix} ;$$

where: J^{T} is the transpose of the geometric Jacobian that maps forces to torques, and τ is the commanded joint torque.

By modulating impedance properties, this step ensures stability, compliance, and precision in response to varying external forces. By integrating real-time force estimation, trajectory adaptation through an admittance model, and controlled torque modulation, the admittance motion control system enables the quadrupedal robot to achieve compliant yet stable locomotion, enhancing safety and robustness in dynamic environments.

In accordance with some embodiments, the controller employing IMM framework can incorporate additional functionalities and alternative approaches for force-aware motion control, trajectory adaptation, and probabilistic state estimation. These enhancements improve the quadrupedal robot's ability to respond to external forces, optimize control decisions, and ensure dynamic stability.

For example, one embodiment uses a model predictive control (MPC) for force-aware motion planning. In some implementations, the controller is further configured to utilize MPC to generate optimized control inputs while explicitly accounting for estimated external forces obtained from the IMM-KF. The MPC framework optimizes control actions by solving a constrained finite-horizon optimization problem that minimizes a cost function, which may include tracking errors, energy consumption, or other performance metrics relevant to motion control.

The controller formulates the MPC optimization problem as:

$${min}_{U} {\sum }_{t = 0}^{N} ( {‖ {x}_{t} - {x}_{d} ‖}_{Q}^{2} + {‖ {u}_{t} ‖}_{R}^{2} ) ;$$

$$subject to :$$

$${x}_{t + 1} = f ( {x}_{t} , {μ}_{t} , {\hat{f}}_{ext} ;$$

$${u}_{min} \leq {u}_{t} \leq {u}_{max} \qquad ( 3 )$$

where: U={u₀, u₁, . . . , u_{N}} is the sequence of control inputs over the prediction horizon, xₜ is the system state at time t, x_{d} is the desired reference state, \hat{f}ₑₓₜ is the estimated external force from the IMM filter, and Q and R are weighting matrices balancing tracking accuracy and control effort.

Alternatively, in some embodiments, the controller utilizes generalized momentum (GM) to compute force pseudo-measurements based on joint encoder data and robot dynamics. The generalized momentum:

$$p = M \dot{q} .$$

By differentiating and incorporating external torques, the force pseudo-measurements are derived:

$${\hat{f}}_{ext} = {( {JM}^{- 1} {J}^{T} )}^{†} ( {JM}^{- 1} {τ}_{m} + J \dot{q} ) .$$

Additionally, in some embodiments, the controller is configured to modify the reference trajectory dynamically based on force pseudo-measurements. For example, the controller can detect collisions by analyzing deviations in force pseudo-measurements and unexpected force spikes. Also, the controller can modify foot trajectory parameters, including step height and swing trajectory, to avoid obstacles. The updated motion states are computed as:

$${r}_{t} = {r}_{t - 1} + {\dot{r}}_{d} Δ t + \frac{1}{2} {{\ddot{r}}_{d} ( Δ t )}^{2} .$$

Additionally or alternatively, the controller can apply admittance control with dynamically adjustable virtual mass, damping, and stiffness:

$${M}^{′} {\ddot{r}}_{d} + {D}^{′} ( {\dot{r}}_{d} - \dot{r} ) + {K}^{′} ( {r}_{d} - r ) = {\hat{f}}_{e x t} ;$$

where M′, D′, K′ are adaptive admittance parameters tuned based on the environmental conditions.

In some embodiments, the probabilistic filter updates mode probabilities based on friction constraints, ensuring realistic contact mode transitions. This is achieved by the following.

First, the controller biases mode transitions using predefined friction cone constraints:

$$‖ {f}_{t}^{‖} ‖ \leq μ ‖ {f}_{t}^{⊥} ‖ ;$$

where:

$${f}_{t}^{‖}$$

is the tangential force,

$${f}_{t}^{⊥}$$

is the normal force, μ is the friction coefficient.

Next, the probabilistic filter dynamically adjusts measurement noise based on the force pseudo-measurement vector's position relative to the friction cone:

$${R}_{t} = {R}_{0} + α ( \frac{‖ {f}_{t} ‖}{‖ {f}_{max} ‖} ) ;$$

where: Rₜ is the updated measurement noise covariance, and R₀ is the baseline noise covariance.

These embodiments provide enhanced force-aware motion control capabilities by integrating MPC-based optimization, generalized momentum for force estimation, dynamic trajectory modification, and friction-based mode probability updates. The combination of these techniques allows the controller to dynamically respond to disturbances, optimize motion efficiency, and ensure robust locomotion stability, making the controller well-suited for operation in unstructured and dynamic environments.

The above description provides exemplary embodiments only, and is not intended to limit the scope, applicability, or configuration of the disclosure. Rather, the above description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the above description to provide a thorough understanding of the embodiments. However, understood by one of ordinary skill in the art may be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination may correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Typically, the functionality of the program modules may be combined or distributed as desired in various embodiments.

Embodiments of the present disclosure may be embodied as a method, of which an example has been provided. The acts performed as part of the method may be ordered in any suitable way. Accordingly, embodiments may be constructed in which acts are performed in an order different than illustrated, which may include performing some acts concurrently, even though shown as sequential acts in illustrative embodiments. Although the present disclosure has been described with reference to certain preferred embodiments, it is to be understood that various other adaptations and modifications may be made within the spirit and scope of the present disclosure. Therefore, it is the aspect of the append claims to cover all such variations and modifications as come within the true spirit and scope of the present disclosure.

1. A probabilistic feedback controller for controlling an operation of a robot using a probabilistic filter employing an interacting multiple-model (IMM) framework, comprising: at least one processor; and a memory having instructions stored thereon that, when executed by the at least one processor, cause the controller to:
process digital representations of measurements of a motion of the robot to estimate force pseudo-measurements of an external force acting on the robot during the motion;
execute an IMM filter configured to recursively estimate the external force using multiple probabilistic filters tracking the external force according to the force pseudo-measurements, each of the multiple probabilistic filters is associated with distinct dynamics of a mode of the motion of the robot to produce a force estimation of the mode and a probability of the mode, wherein the IMM filter combines the force estimation of different modes according to their probabilities to produce the estimate of the external force; and
control the operation of the robot based on the estimate of the external force using one or both of a reflex motion control and an admittance motion control.

2. The controller of claim 1, wherein each of the probabilistic filters is a Kalman filter, such that the IMM filter includes an IMM-Kalman filter.

3. The controller of claim 2, wherein the IMM-Kalman filter is configured to recursively estimate the external force by switching between multiple probabilistic filters, wherein the switching is governed by a Markov chain that models the probabilities of the modes.

4. The controller of claim 1, wherein the robot is a quadrupedal robot configured to operate with distinct modes corresponding to its gait phases.

5. The controller of claim 4, wherein the controller is configured to control the quadrupedal robot by:
monitoring joint kinematics and dynamics of the quadrupedal robot to compute pseudo-measurements of the external force;
assigning a dedicated probabilistic filter to each of multiple operational modes, including a swing mode, a stance mode, and a collision mode, each of the multiple operational modes is characterized by distinct dynamic properties;
utilizing the IMM filter to determine the probability of each mode being active based on the motion of the robot and the computed pseudo-measurements;
refining the estimate of the external force by combining outputs of mode-specific probabilistic filters; and
applying admittance control to adjust a trajectory of the robot based on the refined estimate of the external force.

6. The controller of claim 1, wherein each probabilistic filter within the IMM filter is a Kalman filter configured to track estimates of the external forces, utilizing a process model subject to process noise, and a measurement model subject to measurement noise, wherein the process model of each probabilistic filter corresponds to either a swing mode or a contact mode for predicting the external forces, and the measurement model corresponds to one of a swing mode, a stance mode, or a collision mode to adapt the predictions of the process model based on the force pseudo-measurements.

7. The controller of claim 1, wherein at least some iterations of the IMM filter comprise:
an interaction step, wherein the estimates from multiple probabilistic filters are mixed to generate a combined initial estimate for the filters;
a filtering step, wherein each probabilistic filter processes the mixed estimate independently to update its state estimate;
a probability update step, wherein innovation residuals from the probabilistic filters are used to update the probabilities of the corresponding modes; and
a combination step, wherein the force estimates from the probabilistic filters, each corresponding to a different mode, are combined into a single estimate as a weighted sum, with the weights determined by updated mode probabilities.

8. The controller of claim 7, wherein the interaction step includes:
mixing state estimates from multiple probabilistic filters based on transition probabilities derived from a Markov chain representing the likelihood of mode transitions;
weighting the state estimates of the probabilistic filters according to their prior probabilities to generate mixed initial conditions for the probabilistic filters; and
propagating the mixed initial conditions to initialize the state and covariance for each probabilistic filter before executing the filtering step.

9. The controller of claim 7, wherein the filtering step includes:
executing each probabilistic filter independently using a mixed state and covariance estimates generated during the interaction step;
applying a process model specific to the corresponding mode of the probabilistic filter to predict the estimates of the external force, accounting for process noise governed by the covariance; and
updating the predicted external force and the covariance using force pseudo-measurements through a mode-specific measurement model, accounting for measurement noise to refine the estimate of the external force and the covariance for each mode.

10. The controller of claim 7, wherein the probability update step includes:
calculating the likelihood of the force pseudo-measurements for each mode based on innovation residuals and the covariance of the corresponding probabilistic filter, wherein an innovation residual of a mode is a difference between the force pseudo-measurements and force measurements predicted for the mode;
updating mode probabilities by combining the calculated likelihoods with prior probabilities of the modes derived from a transition probability matrix; and
normalizing the updated mode probabilities to ensure they sum to one, reflecting a probabilistic representation of mode likelihoods.

11. The controller of claim 7, wherein the combination step includes:
aggregating the estimates of the external forces from multiple probabilistic filters, each corresponding to a distinct mode of operation;
weighting the estimates of the external forces by the updated probabilities of their respective modes obtained during the probability update step; and
producing a combined state estimate as a weighted sum, wherein the weights reflect the likelihood of each mode being active.

12. The controller of claim 1, wherein the controller is configured to implement reflex motion control by:
detecting external disturbances through the estimated external forces provided by the IMM filter; and
generating corrective motion commands in real time by adjusting at least one of joint torques or positions to counteract the detected disturbances, wherein the reflex motion control dynamically selects and switches between predefined reflex strategies based on the identified operational mode of the robot, including swing, stance, or collision modes; and
scaling the corrective motion commands proportionally to the magnitude and direction of the estimated external forces to maintain balance, stability, and disturbance rejection while minimizing excessive contact forces.

13. The controller of claim 1, wherein the controller is configured to implement admittance motion control by:
converting the estimated external forces from the IMM filter into a desired motion trajectory by applying an admittance model that relates external forces to one or a combination of position, velocity, or acceleration of the robot;
dynamically adjusting the motion trajectory of the robot in response to changes in the desired motion trajectory; and
controlling one or more motion parameters along the adjusted motion trajectory, including joint torques, damping coefficients, or stiffness values of actuators of the robot.

14. The controller of claim 1, wherein the controller is further configured to utilize model predictive control (MPC) to:
generate a sequence of control inputs by solving an optimization problem that minimizes a cost function representing tracking errors, energy consumption, or other performance metrics over a finite prediction horizon;
incorporate the estimated external forces from the IMM filter as constraints or disturbances within the optimization problem to enhance prediction accuracy of system dynamics; and
update the control inputs in real time by re-solving the optimization problem at each control iteration.

15. The controller of claim 1, further configured to utilize generalized momentum to calculate the force pseudo-measurements based on joint encoder information and robot dynamics.

16. The controller of claim 15, wherein the controller is further configured to modify reference trajectory of the robot dynamically by:
detecting collisions based on the force pseudo-measurements derived from joint kinematics;
updating foot trajectory parameters, including step height and swing trajectory, to avoid obstacles; and
applying admittance control with adjustable virtual mass, damping, and stiffness coefficients to achieve smooth trajectory adjustments during unexpected environmental interactions.

17. The controller of claim 1, wherein the probabilistic filter is configured to update mode probabilities by:
incorporating constraints from predefined friction cones for different modes to bias the likelihood of mode transitions; and
dynamically adjusting measurement noise in the probabilistic filter in response to a position of a vector of the force pseudo-measurements relative to the friction cone.

18. A method for controlling a quadrupedal robot using probabilistic force estimation and adaptive motion control, wherein the method uses a processor coupled with stored instructions implementing the method, wherein the instructions, when executed by the processor carry out steps of the method, comprising:
processing digital representations of measurements of the motion of the robot to estimate force pseudo-measurements corresponding to external forces acting on the robot;
executing an interacting multiple-model (IMM) filter to recursively estimate external forces, wherein the IMM filter comprises multiple probabilistic filters, each associated with a distinct motion mode of the robot, including swing, stance, and collision modes;
determining the probability of each motion mode being active based on the estimated force pseudo-measurements and robot dynamics, wherein the IMM filter updates mode probabilities and refines the external force estimation by combining the outputs of the mode-specific probabilistic filters; and
generating motion control commands based on the estimated external forces, wherein the controller applies one or both of reflex motion control and admittance motion control to modify the trajectory of the quadrupedal robot in response to disturbances and control the robot according the modified trajectory.

19. The method of claim 18, wherein each probabilistic filter within the IMM filter is a Kalman filter configured to track estimates of the external forces, utilizing a process model subject to process noise, and a measurement model subject to measurement noise, wherein the process model of each probabilistic filter corresponds to either a swing mode or a contact mode for predicting the external forces, and the measurement model corresponds to one of a swing mode, a stance mode, or a collision mode to adapt the predictions of the process model based on the force pseudo-measurements.

20. The method of claim 18, wherein at least some iterations of the IMM filter comprise:
an interaction step, wherein the estimates from multiple probabilistic filters are mixed to generate a combined initial estimate for the filters;
a filtering step, wherein each probabilistic filter processes the mixed estimate independently to update its state estimate;
a probability update step, wherein innovation residuals from the probabilistic filters are used to update the probabilities of the corresponding modes; and
a combination step, wherein the force estimates from the probabilistic filters, each corresponding to a different mode, are combined into a single estimate as a weighted sum, with the weights determined by the updated mode probabilities.
